(19) United States
(12) Patent Application Publication
(10) Pub. No.: US 2009/0226833 A1
(43) Pub. Date: Sep. 10, 2009

(54) ELECTROPHOTOGRAPHIC TONER, METHOD FOR MANUFACTURING THE SAME, ELECTROPHOTOGRAPHIC DEVELOPING AGENT, TONER CARTRIDGE, PROCESS CARTRIDGE AND IMAGE FORMING APPARATUS

(75) Inventors: Shuji SATO, Kanagawa (JP); Atsushi SUGAWARA, Kanagawa (JP); Eisuke IWAZAKI, Kanagawa (JP); Hiroshi NAKAZAWA, Kanagawa (JP); Masanobu NINOMIYA, Kanagawa (JP); Kazufumi TOMITA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/236,133

(22) Filed: Sep. 23, 2008

(30) Foreign Application Priority Data
Mar. 10, 2008 (JP) 2008-060128

(51) Int. Cl. G03G 9/00; G03G 5/00

(52) U.S. Cl. 430/105; 430/108.5; 430/108.23; 430/108.21; 430/110.4; 430/110.3; 430/137.14

(57) ABSTRACT

There is provided an electrophotographic toner, which includes a binder resin and a colorant, wherein, with a total intensity (kcps) of all elements detected in the toner due to fluorescent X-ray measurement designated as A and an intensity of nitrogen designated as B, B/A is from about 0.01 to about 0.5, and a ratio of nitrogen measured by X-ray photoelectron spectrometry after ion etching at an accelerating voltage of 10 mV for 180 seconds is from about 0.1 atom % to about 7.5 atom %.

### CROSS-REFERENCE TO RELATED APPLICATION

This application is based on and claims priority under 35USC 119 from Japanese Patent Application No. 2008-060128 filed Mar. 10, 2008.

### BACKGROUND

1. Technical Field

The present invention relates to an electrophotographic toner, a method for manufacturing the same, an electrophotographic developing agent, a toner cartridge, a process cartridge and an image forming apparatus.

2. Related Art

An image forming apparatus according to a so-called xerography process includes an electrophotographic photoreceptor (hereinafter, in some cases, referred to as “a photoreceptor”), a charging device, an exposing device, a developing device and a transferring device and forms an image according to an electrophotographic process therewith. In recent years, an image forming apparatus according to a xerography process has achieved, owing to technical development of the respective members and systems, a faster speed, a higher image quality and a longer lifetime.

In image formation according to a xerography process, various attempts have been carried out.

### SUMMARY

According to an aspect of the invention, there is provided an electrophotographic toner including: a binder resin; and a colorant, with a total intensity (kcps) of all elements detected in the toner due to fluorescent X-ray measurement designated as A and an intensity of nitrogen designated to B, B/A being from about 0.01 to about 0.5; and a ratio of nitrogen measured by X-ray photoelectron spectrometry after ion etching at an accelerating voltage of 10 mV for 180 seconds being from about 0.1 atom % to about 7.5 atom %.

### BRIEF DESCRIPTION OF THE DRAWINGS

Exemplary embodiment(s) of the present invention will be described in detail based on the following figures, wherein:

FIG. 1 is a schematic constitutional diagram showing an example of an image forming apparatus; and

FIG. 2 is a schematic constitutional diagram showing an example of a process cartridge.

### DETAILED DESCRIPTION

According to a first aspect of the invention, there is provided an electrophotographic toner that include a binder resin and a colorant, wherein, with a total intensity (kcps) of all elements detected in the toner due to fluorescent X-ray measurement designated as A and an intensity of nitrogen designated to B, B/A being 0.01 to 0.5 or from about 0.01 to about 0.5; and a ratio of nitrogen measured by X-ray photoelectron spectrometry after ion etching at an accelerating voltage of 10 mV for 180 seconds being 0.1 atom % to 7.5 atom % or from about 0.1 atom % to about 7.5 atom %.

According to a second aspect of the invention, there is provided the electrophotographic toner of the first aspect, wherein a weight average molecular weight of the binder resin is 10,000 or more or about 10,000 or more.

According to a third aspect of the invention, there is provided the electrophotographic toner of the first aspect, wherein the colorant includes a pigment and an aliphatic sulfonate and/or aromatic sulfonate having 6 to 20 carbon atoms.

According to a fourth aspect of the invention, there is provided the electrophotographic toner of the third aspect, wherein the colorant is obtained by mixing an aliphatic sulfonate and/or aromatic sulfonate having 6 to 20 carbon atoms with a synthesized and washed wet cake pigment, followed by heating.

According to a fifth aspect of the invention, there is provided the electrophotographic toner of the first aspect, wherein the colorant contains a colorant having a structure in which at least an azo group bonds to a benzene ring or a naphthalene ring.

According to a sixth aspect of the invention there is provided the electrophotographic toner of the first aspect, wherein the colorant contains a copper phthalocyanine pigment.

According to a seventh aspect of the invention, there is provided an electrophotographic toner of the first aspect, wherein the colorant is formed by containing a quinacridone pigment.

According to a eighth aspect of the invention, there is provided the electrophotographic toner of the first aspect, wherein the colorant contains a monoazo pigment.

According to a ninth aspect of the invention, the electrophotographic toner of the first aspect, wherein a volume average particle size distribution index GSDv of the toner is 1.28 or less or about 1.28 or less.

According to a tenth aspect of the invention, there is provided the electrophotographic toner of the first aspect, wherein an average circularity of the toner is from 0.940 to 0.980 or from about 0.940 to about 0.980.

According to a eleventh aspect of the invention, there is provided the electrophotographic toner of the first aspect, further comprising at least two external additives (low hardness external additive and high hardness external additive) having different Mohs hardness.

According to a twelfth aspect of the present invention, there is provided the electrophotographic toner of the eleventh aspect, wherein the Mohs hardness of the low hardness external additive is from 2 to 6 or from about 2 to about 6.

According to a thirteenth aspect of the invention, there is provided the electrophotographic toner of the eleventh aspect, wherein a content ratio of the low hardness external additive and the high hardness external additive (low hardness external additive: high hardness external additive, % by weight) is from 20:80 to 80:20 or from about 20:80 to about 80:20.

According to a fourteenth aspect of the invention, there is provided the electrophotographic toner of the first aspect, wherein the electrophotographic toner is produced by a process comprising: dispersing a colorant; preparing a colorant dispersion for preparing a colorant dispersion by charging a chelate dispersion to the dispersed colorant, followed by mixing and agitating; forming aggregated particles by mixing a resin fine particle dispersion in which resin fine particles are dispersed and the colorant dispersion; and fusing and coalescing by heating the aggregated particles at a temperature equal to or greater than the glass transition temperature of the resin fine particles.

According to a fifteenth aspect of the invention, there is provided an electrophotographic developing agent comprising the electrophotographic toner of the first aspect.

According to a sixteen aspect of the invention, there is provided a toner cartridge that is detachable from an image forming apparatus provided with at least a toner image forming unit and stores a developing agent containing a toner for being supplied to the toner image forming unit, the toner being the electrophotographic toner of the first aspect.

According to a seventeen aspect of the invention, there is provided a process cartridge that is detachable from an image forming apparatus, the process cartridge comprising at least: an image holding member; and toner image forming unit that stores a developing agent and supplies the developing agent to an electrostatic latent image formed on the image holding member surface to form a toner image, the developing agent being the electrophotographic developing agent of the fifteenth aspect.

According to a eighteen aspect of the invention, there is provided an image forming apparatus comprising at least: an image holding member; a charging unit for charging a surface of the image holding member; an electrostatic latent image forming unit for forming an electrostatic latent image on a surface of the charged image holding member; a toner image forming unit for forming a toner image by developing the electrostatic latent image with a developing agent; a transferring unit for transferring the toner image onto a recording medium surface; a fixing unit for fixing the toner image transferred onto the surface of the recording medium; and a cleaning unit for removing toner remaining on the surface of the image holding member after transferring, the developing agent being the electrophotographic developing agent of the fifteenth aspect.

According to a nineteenth aspect of the invention, there is provided the image forming apparatus of the eighteenth aspect, wherein the image holding member is an electrophotographic image holding member having an outermost surface layer, and an oxygen permeability of the outermost surface layer is 2,500 fm/s·Pa or less or about 2,500 fm/s·Pa or less.

The present invention will be illustrated in more detail by the exemplary embodiments shown below.

### <Electrophotographic Toner>

An electrophotographic toner of the exemplary embodiment of the invention (hereinafter, in some cases, referred to as “a toner of the exemplary embodiment”) includes a binder resin and a colorant, wherein, with a total intensity (kcps) of entire elements detected in the toner owing to fluorescent X-ray measurement assigned to A and an intensity of a nitrogen element assigned to B, B/A is 0.01 to 0.5 or from about 0.01 to about 0.5; and a ratio of nitrogen measured by X-ray photoelectron spectrometry after ion etching at an accelerating voltage of 10 mV for 180 seconds is 0.1 atom % to 7.5 atom % or from about 0.1 atom % to about 7.5 atom %.

In the exemplary embodiment, the fluorescent X-ray measurement is carried out under a vacuum atmosphere (a degree of vacuum: 10 Pa to 100 Pa), at an accelerating voltage of 40 kV, a current value of 70 mV and a measurement time of 15 min, and an intensity ratio of an element derived from the pigment (herein, nitrogen element) to a sum total of intensities of detected elements is calculated. Herein, examples of elements detected by the fluorescent X-ray measurement include B, C, N, O, F, Na, Mg, Al, Si, P, S, Cl, Ti, K, Ca and Sn.

When the B/A is smaller than 0.01, it unit that a content of a particular pigment kind in a toner surface is less to be deficient in the coloring property. On the other hand, when the B/A exceeds 0.5, although the coloring property is sufficient in many cases, a dispersion state of the pigment is deteriorated and, in some cases, it is observed that the color reproducibility varies and the transparency is deteriorated. The B/A is preferably in a range of 0.02 or more to 0.45 or less and more preferably in a range of 0.03 or more to 0.40 or less.

In the exemplary embodiment, X-ray photoelectron spectrometry (XPS) is carried out under conditions of an accelerating voltage of 20 kV and a current value of 10 mA by use of JPS9000MX (trade name, manufactured by JEOL. Ltd.).

Furthermore, according to a study of the inventors, it is found that, similarly to an amount of the pigment exposed on a toner surface, as to the proximity of a surface as well, by the X-ray photoelectron spectrometry after the ion etching, an amount of a particular element derived from a pigment molecule may be specified. Still furthermore, it is found that, even in one that is described in the Patent Documents and restricts an amount exposed on a surface, an amount after ion etching increases.

An amount of the pigment in the proximity of a surface is assumed to cause, during a long term use, the deterioration of the electric characteristics of itself and, due to an adhesion of the component, damage on the image holding member and the image failure. However, these have not been fully studied and a specific countermeasure has not been proposed.

In the exemplary embodiment, the ion etching is carried out under an Ar atmosphere, under conditions of an accelerating voltage of 400±10 V and a degree of vacuum of (3±1)×10⁻² Pa, at an accelerating voltage of a toner surface of 10 mV for 180 sec, and the ion-etched toner surface is subjected to X-ray photoelectron spectrometry to obtain a content of atoms (nitrogen atoms) derived from the pigment particle.

Furthermore, when a ratio of nitrogen measured by X-ray spectrometry after the ion etching is less than about 0.1 atom %, although there is no practical inconvenience, the colorant may be localized inside; accordingly, in some cases, the coloring power or color reproducibility may change. On the other hand, when the ratio of a nitrogen element exceeds about 7.5 atom %, it unit that nitrogen atoms are present much in the proximity of the surface; accordingly, deterioration in the maintainability of the electric characteristics, adhesion of localized pigment component to a image holding member or scratch generation on the image holding member may be caused.

A preferable range of a ratio of nitrogen element due to X-ray photoelectron spectrometry after the ion etching is from 0.2 to 7.0 and a more preferable range is from 0.3 to 6.8 or less.

In the exemplary example of the invention, the fluorescent X-ray measurement may be carried out by use of a known measurement device such as XRF1500 (trade name, manufactured by Shimadzu Corporation).

A toner of the exemplary embodiment, in which the B/A is from 0.01 to 0.5 or from about 0.01 to about 0.5; and a ratio of nitrogen measured by X-ray photoelectron spectrometry after ion etching at an accelerating voltage of 10 mV for 180 seconds being from 0.1 atom % to 7.5 atom % or from about 0.1 atom % to about 7.5 atom %, as will be described below, is obtained by use of a colorant dispersion prepared by pouring a chelate dispersion to a dispersed colorant followed by mixing and agitating.

Next, constituents and various physical properties of the toner of the exemplary embodiment will be detailed below.

### —Binder Resin—

In the toner of the exemplary embodiment, as a binder resin, a crystalline resin is preferably used. Furthermore, as needs arise, a non-crystalline resin is particularly preferably used together.

In the exemplary embodiment, a “crystalline resin” unit one that has a distinct endothermic peak (a peak where a half-value width of an endothermic peak is 10° C. or less) in the differential scanning calorimetry (DSC), and a “non-crystalline resin” unit one that does not have the distinct peak. Furthermore, irrespective of the crystalline resin and non-crystalline resin, a weight average molecular weight of the binder resin is particularly preferably 10000 or more and a weight average molecular weight is usually preferably in a range of from 15,000 to 50,000.

Examples of the crystalline resins include a polyester resin and a crystalline vinyl resin; and examples of the non-crystalline resins include a polyester resin, a polyurethane resin, an epoxy resin and a polyol resin. In what follows, the binder resins used in the invention will be described separated in the crystalline resin and non-crystalline resin.

### —Crystalline Resin—

A content of a crystalline resin contained in a toner mother particle is preferably in a range of 2% by weight to 30% by weight and more preferably in a range of 3% by weight to 15% by weight. When the content of the crystalline resin is less than 2% by weight, in some cases, fixation in a low temperature region becomes difficult. On the other hand, in the case where the content of the crystalline resin exceeds 30% by weight, in particular when the fixation is applied in a medium temperature region or a high temperature region, gloss unevenness tends to be generated or filming tends to be generated. In the toner of the exemplary embodiment, as will be described below, an external additive is preferably added. In the specification, in some cases, a toner before an external additive is added is called a “toner mother particle”.

The melting point of the crystalline resin is preferably in a range of 45° C. to 110° C., more preferably in a range of 50° C. to 100° C. and even more preferably in a range of 55° C. to 90° C.

When the melting point is lower than 45° C., the toner becomes difficult to store and, when the melting point exceeds 110° C., in some cases, the fixation in a low temperature region (hereinafter, in some cases, referred to as the “low temperature fixability”) becomes difficult. The melting point of the crystalline resin unit one obtained by a method according to ASTMD3418-8.

A number average molecular weight (Mn) of the crystalline resin is preferably about 5,000 or more, more preferably about 7,000 or more, and even more preferably about 10,000 or more. When the number average molecular weight (Mn) is less than 5,000, at the time of fixation, in some cases, the toner permeates in a surface of a recording medium such as paper to cause fixing unevenness or to deteriorate the resistance to bending of a fixed image.

As the crystalline resin, as mentioned above, a crystalline polyester resin or a crystalline vinyl resin may be used. However, from the viewpoints of the adhesion and chargeability to paper at the time of fixation and easiness of obtaining a melting point satisfying the range described above, a crystalline polyester resin is preferably used, and in particular from the viewpoint of readily obtaining a resin having a desired melting point, an aliphatic crystalline polyester resin is more preferred.

Specific examples of the crystalline vinyl resin include vinyl resins using long-chain alkyl or alkenyl(meth)acrylates such as amyl(meth)acrylate, hexyl(meth)acrylate, heptyl(meth)acrylate, octyl(meth)acrylate, nonyl(meth)acrylate, decyl(meth)acrylate, undecyl(meth)acrylate, tridecyl(meth)acrylate, myristyl(meth)acrylate, cetyl(meth)acrylate, stearyl(meth)acrylate, oleyl(meth)acrylate and behenyl(meth)acrylate. In the specification, the term “(meth)acryl” includes both “acryl” and “methacryl” in its scope.

The crystalline polyester resin is synthesized from a carboxylic acid (dicarboxylic acid) component and an alcohol (diol) component. Hereinafter, the carboxylic acid component and the alcohol component are described in more detail. In the invention, the scope of the “crystalline polyester resin” includes a copolymer produced by copolymerizing a crystalline polyester resin with another component so that an amount of the another component becomes 50% by weight or less based on an amount of the main chain of the crystalline polyester resin.

The carboxylic acid component is preferably an aliphatic dicarboxylic acid, and is particularly preferably a linear carboxylic acid. Examples thereof include, but are not limited to, oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid and 1,18-octadecanedicarboxylic acid, and lower alkyl esters and acid anhydrides thereof.

The carboxylic acid component preferably includes components such as a dicarboxylic acid component having a double bond and a dicarboxylic acid component having a sulfonic acid group, besides the aliphatic dicarboxylic acid component. The scope of the “dicarboxylic acid component having a double bond” includes not only components derived from dicarboxylic acids having double bonds but also components derived from lower alkyl esters or acid anhydrides of dicarboxylic acids having double bonds. The scope of the “dicarboxylic acid component having a sulfonic acid group” includes not only components derived from dicarboxylic acids having sulfonic acid groups but also components derived from lower alkyl esters or acid anhydrides of dicarboxylic acids having sulfonic acid group.

The dicarboxylic acid having a double bond can be preferably used due to its ability to crosslink the entire resin by utilizing double bonds so as to prevent hot offset upon fixation. Examples of the dicarboxylic acid include, but are not limited to, fumaric acid, maleic acid, 3-hexenedioic acid and 3-octenedioic acid, and lower alkyl esters and acid anhydrides thereof. Among them, fumaric acid and maleic acid are preferable from the viewpoint of costs.

The dicarboxylic acid having a sulfonic acid group is effective due to its ability to improve dispersing of a colorant such as a pigment or the like. When the entire resin is emulsified or suspended in water to form particles, presence of the sulfonic group enables the emulsification or suspension of the resins without a surfactant as will be described hereinafter. Examples of the dicarboxylic acid having a sulfonic acid group include, but are not limited to, sodium salt of 2-sulfoterephthalate, sodium salt of 5-sulfoisophthalate and sodium salt of sulfosuccinate, and lower alkyl esters and acid anhydrides thereof. Among them, sodium 5-sulfoisophthalate and the like is preferable from the viewpoint of costs.

The content of the carboxylic acid component other than the aliphatic dicarboxylic acid component in the carboxylic acid component (the dicarboxylic acid component having a double bond and/or the dicarboxylic acid component having a sulfonic acid group) is preferably about 1% by constitutinal mole to about 20% by constitutional mole, and more preferably about 2% by constitutional mole to about 10% by constitutional mole.

When the content is less than about 1% by constituent mole, the dispersibility of a pigment in the toner mother particle may be insufficient. When the toner is prepared by the emulsion polymerization aggregation method, the diameter of the emulsified particle in the dispersion increases, and regulation of the toner diameter by aggregation may become difficult.

On the other hand, when the content is greater than about 20% by constituent mole, the crystallinity of the crystalline polyester resin is lowered, the melting point decreases, and the storability of an image may be deteriorated.

When the toner is prepared by the emulsion polymerization aggregation method, the diameter of the emulsified particle in the dispersion is too small to form latex by dissolving the particle in water. In the invention, the “% by constituent mole” refers to percentage where the amount of each component (carboxylic acid component, alcohol component) in the polyester resin is 1 unit (mol).

The alcohol component is preferably an aliphatic diol, and examples thereof include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, and the like.

The alcohol component contains preferably about 80% by constituent mole or more of aliphatic diol component. The alcohol component may further contain other components if necessary. More preferably, the alcohol component contains about 90% by constituent mole or more of the aliphatic diol component.

When the content is less than about 80% by constituent mole, the melting point is lowered due to a decrease of the crystallinity of the polyester resin, and thus toner blocking properties, image storability, or fixability at low-temperature may be deteriorated.

Examples of the other components contained if necessary include components such as a diol component having a double bond or a diol component having a sulfonic acid group.

Examples of the diol component having a double bond includes 2-butene-1,4-diol, 3-butene-1,6-diol, 4-butene-1,8-diol, etc. On the other hand, examples of the diol component having a sulfonic acid group includes sodium salt of benzene 1,4-dihydroxy-2-sulfonate, sodium salt of benzene 1,3-dihydroxymethyl-5-sulfonate, sodium salt of 2-sulfo-1,4-butanediol and the like.

When these alcohol components (the diol component having a double bond and/or the diol component having a sulfonic acid group) other than the linear aliphatic diol component are added, the content thereof in the alcohol component is preferably about 1 to 20 mol % by constituent mole, more preferably about 2 to 10 mol % by constituent mole. When the content is less than about 1 mol %, there is the case where the dispersion of a pigment is insufficient, the diameter of the emulsified particle is increased, or regulation of the toner diameter by aggregation becomes difficult. On the other hand, when the content is greater than about 20 mol % by constituent mole, there is the case where the crystallinity of the polyester resin is decreased, the melting point is lowered, the storability of an image is deteriorated, or the diameter of the emulsified particle is so small that the toner dissolves in water, thus failing to form latex.

The method of producing the crystalline polyester resin is not particularly limited, and the resin can be produced by a general method of polymerizing a polyester by reacting a carboxylic acid component with an alcohol component, such as a direct polycondensation method or an ester exchange method, and a suitable method is selected depending on the type of monomer. The molar ratio of the acid component to the alcohol component (acid component/alcohol component) to be reacted with each other varies depending on reaction conditions etc., and cannot be generalized, but is usually about 1/1.

Production of the crystalline polyester resin can be carried out at a polymerization temperature of about 180° C. to about 230° C., and the reaction is carried out in the reaction system if necessary under reduced pressure while water and alcohol generated upon condensation are removed. When the monomers are not dissolved or mutually dissolved at the reaction temperature, a solvent having a high-boiling point may be added as an auxiliary stabilizer to dissolve the monomers. Polycondensation is carried out while the auxiliary solubilizing solvent is distilled away. When there is a monomer which is poor in compatibility in copolymerization, it is preferred that the monomer which is poor in compatibility is previously condensed with an intended carboxylic acid component or alcohol component and then copolymerized with a major component.

Examples of a catalyst usable in production of the crystalline polyester resin include alkali metal compounds of sodium, lithium, etc.; alkaline earth metal compounds of magnesium, calcium, etc.; metal compounds of zinc, manganese, antimony, titanium, tin, zirconium, germanium, etc.; and phosphite compounds, phosphate compounds, amine compounds, and the like.

Specific examples of the catalyst include sodium acetate, sodium carbonate, lithium acetate, calcium acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenyl antimony, tributyl antimony, tin formate, tin oxalate, tetraphenyl tin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenyl phosphite, tris(2,4-di-t-butylphenyl) phosphite, ethyltriphenyl phosphonium bromide, triethylamine, triphenylamine etc.

From the viewpoints of readily combining the low temperature fixability and the uneven gloss suppressing effect at a high level, among catalysts containing a metal element that has a valency of two or more, calcium acetate and manganese acetate are preferably used.

For regulating the melting point, molecular weight etc. of the crystalline resin, in addition to the polymerizable monomers described above, compounds having a shorter-chain alkyl or alkenyl group, an aromatic ring, etc. can be used.

Specific examples of such compounds include, for the dicarboxylic acid, alkyl dicarboxylic acids such as succinic acid, malonic acid and oxalic acid, aromatic dicarboxylic acids such as phthalic acid, isophthalic acid, terephthalic acid, homophthalic acid, 4,4′-bibenzoic acid, 2,6-naphthalene dicarboxylic acid and 1,4-naphthalene dicarboxylic acid, and nitrogen-containing aromatic dicarboxylic acids such as dipicolinic acid, dinicotinic acid, quinolinic acid and 2,3-pyrazine dicarboxylic acid; for the diols, short-alkyl diols such as succinic acid, malonic acid, acetone dicarboxylic acid and diglycolic acid; and for the vinyl polymerizable monomers containing the short-chain alkyl group, short-chain alkyl or alkenyl (meth)acrylates such as methyl (meth)acrylate, ethyl(meth)acrylate, propyl(meth)acrylate and butyl(meth)acrylate, vinyl nitrites such as acrylonitrile and methacrylonitrile, vinyl ethers such as vinyl methyl ether and vinyl isobutyl ether, isopropenyl ketones such as vinyl methyl ketone, vinyl ethyl ketone and vinyl isopropenyl ketone, and olefins such as ethylene, propylene, butadiene and isoprene. These polymerizable monomers may be used singly or two or more of them may be used in combination.

### —Non-Crystalline Resin—

In the toner of the exemplary embodiment, as a binder resin, a non-crystalline resin may be used together with a crystalline resin.

A molecular weight of a usable non-crystalline resin is not particularly restricted. However, when a toner is produced by use of an emulsion polymerization aggregation method described below, a non-crystalline resin high in the weight average molecular weight (Mw) (high molecular weight component) and a non-crystalline resin low in the weight average molecular weight (low molecular weight component) are preferably used.

In this case, Mw of the high molecular weight component is preferably 30,000 to 300,000, more preferably 30,000 to 200,000 and particularly preferably 35,000 to 150,000. When the Mw of the high molecular weight component is controlled in the above range, the non-crystalline resin is made more efficiently mutually dissolved with the crystalline resin and, moreover, is inhibited from separating from once mutually dissolved crystalline resin.

On the other hand, Mw of the low molecular weight component is preferably 8,000 or more to 25,000 or less, more preferably 8,000 or more to 22,000 or less and particularly preferably 9,000 or more to 200,000 or less.

By controlling the Mw of the low molecular weight component in the above range, when aggregated particles obtained by flocculating raw material components according to an emulsion polymerization aggregation method are heated to fuse, the inclusivity of the low molecular weight component in the toner mother particle becomes excellent, and thereby the crystalline resin is inhibited from exposing on a surface of the toner mother particle.

As mentioned above, when a high molecular weight component and a low molecular weight component are mixed and used, a blending ratio thereof is, in terms of high molecular weight component/low molecular weight component, preferably in a range of 35/65 to 95/5, more preferably in a range of 40/60 to 90/10 and even more preferably in a range of 50/50 to 85/15.

The high molecular weight component preferably contains, as constituent monomers, alkenyl succinic acid or an anhydride thereof and trimellitic acid or an anhydride thereof. Alkenyl succinic acid or an anhydride thereof is, owing to the presence of an alkenyl group high in the hydrophobicity, more readily mutually dissolved with a crystalline polyester resin.

In the exemplary embodiment, a molecular weight distribution is measured by use of HLC-8120GPC, SC-8020 device (trade name, manufactured by Tosoh Corporation), with TSK gei, Super HM-H (6.0 mm ID×15 cm×2) as columns and THF (tetrahydrofuran) as an eluate. As measurement conditions, a sample concentration is set at 0.5%, a flow rate at 0.6 ml/min, a sample injection amount at 10 μl and a measurement temperature at 40° C. A calibration curve is prepared of 10 samples of A-500, F-1, F-10, F-80, F-380, A-2500, F-4, F-40, F-128 and F-700. A data collection interval in the sample analysis is set at 300 ms.

Examples of alkenylsuccinic acid components include n-dodecenylsuccinic acid, isododecenylsuccinic acid, n-octenylsuccinic acid and acid anhydrides thereof, acid chlorides thereof and esters thereof with lower alkyl esters having 1 to 3 carbon atoms. When a polyvalent carboxylic acid having a valency of three or more is contained, the molecule chain can take a crosslinking structure. When a crosslinking structure is taken, a once mutually dissolved crystalline polyester resin is immobilized and made difficult to separate. Examples of the polyvalent carboxylic acid having a valency of three or more include hemimellitic acid, trimellitic acid, trimesic acid, mellophanic acid, prehnitic acid, pyromellitic acid, mellitic acid, 1,2,3,4-butanetetracarboxylic acid and acid anhydrides thereof, acid chlorides thereof and esters thereof with alkyl having 1 to 3 carbon atoms.

The method of producing the non-crystalline polyester resin is not particularly limited, and the non-crystalline polyester resin can be produced by the general polyester polymerization method described above. Examples of the carboxylic acid component used in synthesis of the non-crystalline polyester resin include various dicarboxylic acids mentioned for the crystalline polyester resin. Examples of the alcohol component also include various diols used in synthesis of the non-crystalline polyester resin, and it is possible to use bisphenol A, ethylene oxide adduct of bisphenol A, propylene oxide adduct of bisphenol A, hydrogenated bisphenol A, bisphenol S, ethylene oxide adduct of bisphenol S, propylene oxide adduct of bisphenol S or the like in addition to the aliphatic diols mentioned for the crystalline polyester resin.

From the viewpoints of toner productivity, heat resistance and transparency, bisphenol S and bisphenol S derivatives such as ethylene oxide adduct of bisphenol S and propylene oxide adduct of bisphenol S are preferably used. The carboxylic acid component and alcohol component each may contain plural components, and particularly, bisphenol S has an effect of improving heat resistance.

### —Cross Linking Treatment of Binder Resin and the Like—

Further, crosslinking treatment of the crystalline resin used as a binder resin, crosslinking treatment of the non-crystalline resin which is used if necessary, and copolymerizable components usable in synthesis of the binder resin, are explained in detail.

For synthesis of the binder resin, other additional components can be copolymerized, and compounds having hydrophilic polar groups can be used.

When the binder resin is a polyester resin, specific examples of the other additional components include dicarboxylic acid compounds having an aromatic ring substituted directly with a sulfonyl group, such as sodium sulfonyl-terephthalate and sodium 3-sulfonyl isophthalate. When the binder resin is a vinyl resin, specific examples of other additional components include unsaturated aliphatic carboxylic acids such as (meth)acrylic acid and itaconic acid, esters of (meth)acrylic acids and alcohols, such as glycerin mono(meth)acrylate, fatty acid-modified glycidyl(meth)acrylate, zinc mono(meth)acrylate, zinc di(meth)acrylate, 2-hydroxyethyl(meth)acrylate, polyethylene glycol(meth)acrylate and polypropylene glycol(meth)acrylate, styrene derivatives having a sulfonyl group in the ortho-, meta- or para-position, and a sulfonyl group-substituted aromatic vinyl such as sulfonyl group-containing vinyl naphthalene and the like.

A crosslinking agent can be added if necessary to the binder resin for the purpose of preventing uneven gloss, uneven coloration and hot offset, upon fixation at a high-temperature region.

Specific examples of the crosslinking agent include aromatic polyvinyl compounds such as divinyl benzene and divinyl naphthalene, polyvinyl esters of aromatic polyvalent carboxylic acids such as divinyl phthalate, divinyl isophthalate, divinyl terephthalate, divinyl homophthalate, divinyl/trivinyl trimesate, divinyl naphthalene dicarboxylate and divinyl biphenyl carboxylate, divinyl esters of nitrogen-containing aromatic compounds, such as divinyl pyridine dicarboxylate, unsaturated heterocyclic compounds such as pyrrole and thiophene, vinyl esters of unsaturated heterocyclic carboxylic acids, such as vinyl pyromucate, vinyl furan carboxylate, vinyl pyrrole-2-carboxylate and vinyl thiophene carboxylate, (meth)acrylates of linear polyvalent alcohols, such as butane diol methacrylate, hexane diol acrylate, octane diol methacrylate, decane diol acrylate and dodecane diol methacrylate, branched, substituted polyvalent alcohol (meth)acrylates such as neopentyl glycol dimethacrylate, 2-hydroxy-1,3-diacryloxy propane, and polyvalent polyvinyl carboxylates such as polyethylene glycol di(meth)acrylate, polypropylene polyethylene glycol di(meth)acrylates, divinyl succinate, divinyl fumarate, vinyl/divinyl maleate, divinyl diglycolate, vinyl/divinyl itaconate, divinyl acetone dicarboxylate, divinyl glutarate, divinyl 3,3′-thiodipropionate, divinyl/trivinyl trans-aconate, divinyl adipate, divinyl pimelate, divinyl suberate, divinyl azelate, divinyl sebacate, dodecane diacid divinyl, divinyl brassylate etc.

Particularly in the crystalline polyester resin, unsaturated polycarboxylic acids such as fumaric acid, maleic acid, itaconic acid and trans-aconic acid are copolymerized with polyester, and then multiple bonds in the resin may be crosslinked with one another or other vinyl compounds may be crosslinked therewith. In the invention, the crosslinking agents may be used singly or two or more of them may be used in combination.

The method of crosslinking by the crosslinking agent may be a method of crosslinking by polymerizing the polymerizable monomer together with the crosslinking agent to crosslink the monomer or a method wherein after the binder resin is polymerized while unsaturated portions are allowed to remain in the binder resin, or after the toner is prepared, the unsaturated portions are crosslinked by crosslinking reaction.

When the binder resin is polyester resin, the polymerizable monomer can be polymerized by condensation polymerization. As the catalyst for condensation polymerization, a known catalyst can be used, and specific examples thereof include titanium tetrabutoxide, dibutyltin oxide, germanium dioxide, antimony trioxide, tin acetate, zinc acetate and tin disulfide. When the binder resin is vinyl resin, the polymerizable monomer can be polymerized by radical polymerization.

The radical polymerization initiator is not particularly limited insofar as it is capable of emulsion polymerization. Specific examples of the radical polymerization initiator include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethyl benzoyl peroxide, lauroyl peroxide, ammonium persulfate, sodium persulfate, potassium persulfate, peroxy carbonate, diisopropyl tetralin hydroperoxide, 1-phenyl-2-methylpropyl-1-hydroperoxide, pertriphenyl acetate-tert-butyl hydroperoxide, tert-butyl performate, tert-butyl peracetate, tert-butyl perbenzoate, tert-butyl perphenylacetate, tert-butyl permethoxyacetate, and tert-butyl perN-(3-toluyl) carbamate, azo compounds such as 2,2′-azobispropane, 2,2′-dichloro-2,2′-azobispropane, 1,1′-azo(methylethyl) diacetate, 2,2′-azobis(2-amidinopropane) hydrochloride, 2,2′-azobis(2-amidinopropane) nitrate, 2,2′-azobisisobutane, 2,2′-azobisisobutylamide, 2,2′-azobisisobutyronitrile, methyl 2,2′-azobis-2-methylpropionate, 2,2′-dichloro-2,2′-azobisbutane, 2,2′-azobis-2-methylbutyronitrile, dimethyl 2,2′-azobisisobutyrate, 1,1′-azobis(sodium 1-methylbutyronitrile-3-sulfonate), 2-(4-methylphenylazo)-2-methylmalonodinitrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methylvaleronitrile, dimethyl 4,4′-azobis-4-cyanovalerate, 2,2′-azobis-2,4-dimethylvaleronitrile, 1,1′-azobiscyclohexanenitrile, 2,2′-azobis-2-propylbutyronitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenyl azodiphenyl methane, phenyl azotriphenyl methane, 4-nitrophenyl azotriphenyl methane, 1,1′-azobis-1,2-diphenyl ethane and poly(bisphenol A-4,4′-azobis-4-cyanopentanoate), poly(tetraethyleneglycol-2,2′-azobisisobutyrate), and 1,4-bis(pentaethylene)-2-tetrazene, 1,4-dimethoxycarbonyl-1,4-diphenyl-2-tetrazene. These polymerization initiators can also be used as initiators for the crosslinking reaction.

The binder resin has been described by referring mainly to the crystalline polyester resin and non-crystalline polyester resin, and if necessary it is also possible to use styrene and styrene compounds such as parachlorostyrene and α-methyl styrene; acrylate monomers such as methyl acrylate, ethyl acrylate, n-propyl acrylate, butyl acrylate, lauryl acrylate and 2-ethylhexyl acrylate; methacrylate monomers such as methyl methacrylate, ethyl methacrylate, n-propyl methacrylate, lauryl methacrylate and 2-ethylhexyl methacrylate; ethylenically unsaturated monomers such as acrylic acid, methacrylic acid and sodium styrenesulfonate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone and vinyl isopropenyl ketone; homopolymers of olefin monomers such as ethylene, propylene and butadiene, copolymers comprising a combination of two or more of these monomers, or mixtures thereof; non-vinyl condensed resins such as epoxy resin, polyester resin, polyurethane resin, polyamide resin, cellulose resin and polyether resin, or mixtures thereof with the vinyl resin, and graft polymers obtained by polymerizing the vinyl monomers in the presence of these resins.

In the case where the resin particle dispersion is formed by emulsion polymerization aggregation method, the resin is prepared in a form of a resin particle dispersion. The resin particle dispersion can be easily obtained by emulsion polymerization or by polymerization which uses a dispersion system similar to emulsion polymerization. Alternatively, the resin particle dispersion can be obtained by any methods such as a method which includes adding, together with a stabilizer, a polymer, which has been uniformly polymerized in advance by solution polymerization or bulk polymerization, to a solvent in which the polymer is not dissolved, and mechanically mixing so as to disperse the resultant.

For example, when a vinyl monomer is used, a resin particle dispersion can be prepared by emulsion polymerization or seed polymerization using an ionic surfactant or the like, preferably a combination of an ionic surfactant and a nonionic surfactant.

Examples of the surfactant used include, but is not limited to, anionic surfactants such as sulfate compounds, sulfonate compounds, phosphate compounds or soap; cationic surfactants such as amine compounds or quaternary ammonium salt compounds; nonionic surfactants such as polyethylene glycol compounds, alkyl phenol/ethylene oxide adduct compounds, alkyl alcohol/ethylene oxide adduct compounds, or polyhydric alcohol compounds, as well as various graft polymers.

When the resin particle dispersion is produced by emulsion polymerization, a small amount of unsaturated acid, for example, acrylic acid, methacrylic acid, maleic acid or styrenesulfonic acid is preferably used as a part of the monomer component so that a protective colloidal layer can be formed on the surfaces of particles to realize soap-free polymerization.

The average particle diameter of the resin particles is preferably about 1 μm or less, more preferably in a range of about 0.01 μm to about 1 μm. When the average particle diameter of the resin particles is greater than about 1 μm, the particle size distribution of the finally obtained toner for electrostatic image development is broadened, and free particles are generated to cause deterioration in performance and reliability. On the other hand, when the average particle diameter of the resin particles is within a range described above, there does not arise the disadvantage described above, and there is an advantage that the uneven distribution of the resin particles among toner particles is decreased, and the dispersion thereof in the toner is improved, thus reducing fluctuation in performance and reliability. The average particle diameter of the resin particles can be measured by using a laser diffraction particle size measuring instrument (trade name: SALD2000A, manufactured by Shimadzu Corporation) or the like.

### —Releasing Agent—

The toner of the exemplary embodiment preferably contains a releasing agent. As the releasing agent, known releasing agents for toner can be used. Examples thereof include low-molecular polyolefins such as polyethylene, polypropylene and polybutene; fatty acid amides such as silicones, oleic acid amide, erucic acid amide, ricinoleic acid amide and stearic acid amide; vegetable wax such as carnauba wax, rice wax, candelila wax, haze wax and jojoba oil; animal wax such as beeswax; mineral or petroleum wax such as montan wax, ozokerite, ceresin, paraffin wax, microcrystalline wax and Fischer Tropsch wax, and modified products thereof.

When the toner is produced by the emulsion polymerization aggregation method, the releasing agent may also be heated to a temperature equal to or higher than the melting point and simultaneously dispersed in water together with an ionic surfactant, or a polyelectrolyte such as a polymeric acid or a polymeric base, finely divided by a homogenizer capable of giving strong shearing force or a pressure discharging dispersing machine, and used as a releasing agent particle dispersion containing releasing agent particles having an average particle diameter of about 1 μm or less.

To prepare the toner, these releasing agent particles together with the other resin particle components may be added to a mixed solvent all at once or several times in divided portions.

The amount of the releasing agent in the toner mother particle is preferably in a range about 0.5% by weight to about 50% by weight. The content is more preferably in a range of about 1% by weight to 30% by weight, and even more preferably in a range of about 5% by weight to 15% by weight. When the content is lower than 0.5% by weight, oil-less fixation becomes difficult in some cases, while when the content exceeds about 50% by weight, the releasing agent does not sufficiently permeate in a surface of an image at the time of fixation, and therby the releasing agent easily remains in the image and the transparency deteriorates in some cases.

An average dispersion diameter of the releasing agent which is dispersed and contained in the toner is preferably in a range of about 0.3 μm to about 0.8 μm, and more preferably in a range of about 0.4 μm to about 0.8 μm.

When the average dispersion diameter of the releasing agent is less than about 0.3 μm, releaseability becomes insufficient in some cases, and particularly when a process speed is high, this tendency becomes more remarkable. On the other hand, when the average dispersion diameter exceeds about 0.8 μn, reduction in transparency upon use of an OHP sheet or exposure of a releasing agent component on a toner surface become remarkable in some cases.

A standard deviation of the dispersion diameter of the releasing agent is preferably about 0.5 or less, and more preferably about 0.04 or less. When the standard deviation of the dispersion diameter of the releasing agent exceeds about 0.05, this adversely influences releaseability, transparency upon use of an OHP sheet, and exposure of the releasing agent on a toner surface in some cases.

The average dispersion diameter of the releasing agent which is dispersed and contained in the toner is obtained by analyzing a TEM (transmission electron microscope) photograph of a cross section of toner mother particle with an image analyzing apparatus (Luzex image analyzing apparatus manufactured by Nireco Corporation), and calculating an average of a dispersion diameter (=(long diameter+short diameter)/2 of the releasing agent in 100 toner mother particles, and a standard deviation is obtained based on individual dispersion diameters obtained in this process.

An exposure ratio of the releasing agent on the toner mother particle surface is preferably in a range of about 5 atom % to about 12 atom %, and further preferably in a range of about 6 atom % to about 11 atom %.

When the exposure ratio is less than about 5 atom %, fixability on a high temperature region may be deteriorated in some cases particularly in a system which is used at a high speed, and when the exposure ratio exceeds about 12 atom %, reduction in developability or transfer property due to uneven distribution or embedding in toner mother particles of an external additive may be observed in some cases in long term use.

Herein, the exposure ratio of the releasing agent on the mother particle surface is obtained by XPS (X-ray Photoelectron Spectroscopy) measurement.

A JPS-9000MX (trade name, manufactured by JEOL Ltd) is used as the XPS measuring apparatus, and measurement is performed by using an MgK α-ray as an X-ray source. An acceleration voltage is set at about 10 kV, and an emission current is set at about 30 mA.

Herein, an amount of a releasing agent on a toner surface is quantitated by a method of separating peaks contents derived from the releasing agent on the toner surface from of C_{1S} spectrum obtained by the above conditions. The peak separating method separates the measured a C_{1S} spectrum into each component using curve fitting by a least square method. As a component spectrum serving as a basis for separation, C_{1S} spectra obtained by measuring each of the releasing agent, the binder resin, and the crystalline resin, which are used for manufacturing the toner, alone are used.

### —Colorant—

The toner of the exemplary embodiment contains a colorant.

The colorant used in the embodiment includes various pigments such as carbon black, chrome yellow, hanza yellow, benzidine yellow, threne yellow, quinoline yellow, permanent orange GTR, pyrazolone orange, vulcan orange, Watchung red, permanent red, brilliant carmine 3B, brilliant carmine 6B, DuPont oil red, pyrazolone red, lithol red, rhodamine B lake, lake red C, rose Bengal, aniline blue, ultramarine blue, chalco oil blue, methylene blue chloride, phthalocyanine blue, phthalocyanine green and malachite green oxalate, various dyes formed of compounds of acridine, xanthene, azo, benzoquinone, azine, anthraquinone, thioindigo, dioxazine, thiazine, azomethine, indigo, phthalocyanine, aniline black, polymethine, triphenyl methane, diphenyl methane or thiazole, and a mixture of two or more of them.

As the colorant used in the exemplary embodiment, a colorant having a structure where at least an azo group (—N═N—) is bonded to a benzene ring or a naphthalene ring is preferably used. As such a colorant, as far as it has the foregoing structure, any one of monoazo pigments, disazo pigments and condensed azo pigments may be used. Among these, from the viewpoints of coloring power and cost, monoazo pigments and disazo pigments are preferred.

Specific examples of colorants having a structure where at least an azo group is bonded to a benzene ring or a naphthalene ring include C.I. Pigment Red 2, 5, 9, 23, 48, 57, 60, 112, 144, 146, 170, 185, 188 and 221, and C.I. Pigment Yellow 1, 3, 6, 14, 17, 74, 81, 83, 93, 95, 97, 128, 139, 152 and 167.

Furthermore, the colorant used in the exemplary embodiment preferably includes at least one of a copper phthalocyanine pigment, a quinacridone pigment or a monoazo pigment.

Examples of the copper phthalocyanine pigments include C.I. Pigment Blue 15:1, 15:2, 15:3, 15:4 and 15:6.

Examples of the quinacridone pigments include C.I. Pigment Red 122 and C.I. Pigment Violet 19.

Examples of the monoazo pigments include C.I. Pigment Yellow 1, 3, 97, 98, 116, 167, 168, 183 and 191.

On the other hand, a colorant used in the exemplary embodiment is used, from the viewpoint of obtaining excellent dispersibility, preferably as a colorant composition containing a pigment and aliphatic sulfonate and/or aromatic sulfonate having 6 to 20 carbon atoms. This is considered that because aliphatic sulfonate and/or aromatic sulfonate having 6 to 20 carbon atoms is mixed in advance in the pigment, cohesive energy of secondary aggregates is small, and thereby the dispersibility in the pigment dispersion step and the dispersion stability are improved. Furthermore, since less energy is consumed in the dispersing, the cost of consumption articles such as media and nozzle may be lowered to improve the production efficiency. Long chain aliphatic sulfonate and/or aromatic sulfonate do not remain on the toner after washing; accordingly excellent toner charging property is obtained.

Still furthermore, the colorant composition is preferably one obtained by mixing, to a synthesized and washed wet cake pigment, aliphatic sulfonate and/or aromatic sulfonate having 6 to 20 carbon atoms, followed by heating.

An example of a preferable embodiment of the colorant composition will be described.

A crystalline pigment synthesized according to various methods is firstly dissolved in strong acid such as nitric acid or sulfuric acid, followed by washing with a lot of water to remove impurities, and, thereby a wet cake pigment is obtained. According to a preferable embodiment of the colorant, to an obtained wet cake pigment, aliphatic sulfonate and/or aromatic sulfonate having 6 to 20 (preferably 8 to 16) carbon atoms is mixed, followed by heating to obtain a colorant composition.

An additive amount of aliphatic sulfonate and/or aromatic sulfonate having 6 to 20 or carbon atoms with respect to a solid content of the wet cake pigment is, from the viewpoint of improving the dispersibility and storage stability, preferably 1% by weight to 20% by weight and more preferably 5% by weight to 15% by weight.

Furthermore, a moisture content in the colorant composition is, from the viewpoint of improving the dispersibility and storage stability, preferably 0.01% by weight to 70% by weight, and more preferably 10% by weight to 50% by weight.

A heating temperature is, from the viewpoint of being capable of applying while suppressing the cohesive force of the colorant and forwarding the dispersibility, preferably 30° C. to 60° C. and more preferably 35° C. to 55° C.

Examples of aliphatic sulfonates and aromatic sulfonates, which have 6 to 20 carbon atoms, include sodium lauryl sulfate, potassium lauryl sulfate, sodium dodecylbenzene sulfonate, sodium dodecylnaphthalene sulfonate, sodium didodecyl sulfosuccinate and sodium dodecyldiphenylether disulfonate, among these sodium dodecylbenzene sulfonate and sodium dodecyl diphenylether disulfonate being preferred.

Furthermore, in the toner of the exemplary embodiment, in order to control the B/A to be within a range of 0.01 to 0.5 or about 0.01 to about 0.5 and a ratio of nitrogen measured by X-ray photoelectron spectroscopy after the ion etching to be within a rage of 0.1 atom % to 7.5 atom % or about 0.1 atom % to about 7.5 atom %, a colorant is preferably prepared as a colorant dispersion by, after dispersing the colorant (colorant dispersing step), pouring a chelate dispersion to the dispersed colorant, followed by mixing and agitating (colorant dispersion preparation step).

As the chelate, known ones based on ammonia, diamine, triamine or tetramine may be preferably used. Specific preferable examples include nitrile triacetic acid, trisodium nitrile triacetate, ethylenediamine and tetrasodium ethylenediamine.

Furthermore, a chelate dispersion is preferred to be a liquid obtained by dispersing the chelate in an aqueous solvent such as water or alcohol. A concentration of the chelate dispersion is preferably 3% by weight to 25% by weight.

Still furthermore, a temperature when the chelate dispersion is poured in the colorant and mixed and agitated is preferably 25° C. to 40° C.

A preferable amount of the chelate dispersion added is, though different depending on the B/A that is a target and a ratio of nitrogen measured by X-ray photoelectron spectroscopy after the ion etching with respect, to 100 parts by weight of the colorant, preferably 0.1 parts by weight to 2 parts by weight and more preferably 0.3 parts by weight to 1.7 parts by weight.

The volume average particle diameter of the colorant particles in the dispersion is preferably about 0.8 μm or less, more preferably in a range of about 0.05 μm to about 0.5 μm. When the average particle diameter of the colorant is greater than about 0.8 μm, the particle size distribution of the finally obtained toner for electrostatic image development is broadened, and free particles are generated, resulting in deterioration in performance or reliability. When the volume average particle diameter of the colorant particles is smaller than about 0.05 μm, coloring properties in the toner are reduced, and shape regulation property that is one feature of the emulsion aggregation method is lost, so a truly spherical toner cannot be obtained in some cases.

The ratio of the number of coarse particles having a volume-average particle diameter of about 0.8 μm or more to the number of the total particles in the colorant particle dispersion is preferably less than about 10% and preferably substantially 0%. The presence of such coarse particles causes deterioration in the stability of the aggregating, generation of free coarse colored particles, or broader particle-size distribution in some cases.

The ratio of the number of fine particles having a volume-average particle diameter of about 0.05 μm or less to the number of the total particles in the colorant particle dispersion is preferably about 5% or less. The presence of such fine particles causes deterioration in the shape regulation property of the toner mother particle in the fusing and coalescing step wherein the aggregated particles are heated and fused, so smooth colorant particles having an average circularity of about 0.940 or less may not be obtained.

On the other hand, when the volume-average particle diameter of the colorant particles, coarse particles and particles are in a ranges described above, there does not arise the disadvantage described above, and there is an advantage that the uneven distribution of the colorant particles among toner particles is decreased, and the dispersion thereof in the toner is improved, thus reducing fluctuation in performance and reliability.

The volume-average particle diameter of the colorant particles can be measured by using a laser diffraction particle size measuring instrument (trade name: SALD2000A, described above) or the like. The amount of the colorant added is preferably in a range of about 1% by weight to about 20% by weight with respect to the toner.

A method of dispersing the colorant in a solvent is not particularly limited, and any method such as that using a rotating shearing homogenizer, a ball mill having a medium, a sand mill or a DYNO-mill can be arbitrarily used.

Examples of the colorant which may be used further include those which are surface-modified with rosin, polymer or the like. The surface-modified colorant is advantageous in that it is sufficiently stabilized in the colorant particle dispersion, and when the colorant is dispersed to a desired average particle diameter in the colorant particle dispersion and mixed with the resin particle dispersion or subjected to the aggregating etc., the colorant particles are not aggregated with one another and can be maintained in an excellent dispersed state. However, a colorant subjected to excessive surface modification may become free without aggregation with the resin particles in the aggregating. Accordingly, the surface modification is conducted under suitably selected optimum conditions.

Examples of the polymer used in surface treatment of the colorant include an acrylonitrile polymer, methyl methacrylate polymer etc.

Examples of the conditions for surface modification include, in general, a polymerization method of polymerizing a monomer in the presence of the colorant (pigment), a phase separation method which includes dispersing the colorant (pigment) in a polymer solution and lowering the solubility of the polymer to precipitate it on the surface of the colorant pigment), and the like.

### —Other Additives—

When the toner of the embodiment is used as a magnetic toner, magnetic powder is contained therein, and examples of the magnetic powder used include metals such as ferrite, magnetite, reduced iron, cobalt, nickel and manganese, alloys thereof and compounds containing the metals. If necessary, a wide variety of ordinarily used charge controlling agents such as quaternary ammonium salts, Nigrosine compounds and triphenylmethane pigments may also be added.

In the toner of the embodiment, inorganic particles can also be contained if necessary. From the viewpoint of durability, it is preferable that inorganic particles having a median particle diameter of about 5 nm to about 30 nm and inorganic particles having a median particle diameter of about 30 nm to about 100 nm are contained in a range of about 0.5% by weight to about 10% by weight relative to the toner.

Specific examples of the inorganic particles include silica, hydrophobated silica, titanium oxide, alumina, calcium carbonate, magnesium carbonate, tricalcium phosphate, colloidal silica, cation surface-treated colloidal silica and anion surface-treated colloidal silica. These inorganic particles have been previously treated in the presence of an ionic surfactant by a sonicator, and colloidal silica which does not require this dispersion treatment is more preferably used.

When the amount of the inorganic particles added is less than about 0.5% by weight, sufficient toughness cannot be achieved at the time of toner melting even if the inorganic particles are added, and releasability at oil-less fixation cannot be improved and coarse dispersion of fine toner particles in the toner upon melting increases viscosity only, resulting in deterioration to cause stringiness which deteriorates releasability of releasing at oil-less fixation. When the content of the inorganic particles is higher than about 10% by weight, although sufficient toughness can be attained, fluidity upon toner melting is significantly reduced to deteriorate image gloss.

A known external additive can be externally added to the toner of the embodiment. Examples of the external additive include inorganic particles such as silica, alumina, titania, calcium carbonate, magnesium carbonate or tricalcium phosphate. For example, inorganic particles such as silica, alumina, titania and calcium carbonate and resin particles such as vinyl resin, polyester and silicone can be used as a flowability auxiliary agent, a cleaning auxiliary agent or the like. The method of adding the external additive is not particularly limited, and the external additive in a dried state can be added onto the surfaces of the toner particles with shearing force.

The toner of the exemplary embodiment preferably contains at least two external additives different in the Mohs hardness. By containing at least two of external additives different in the Mohs hardness, an external additive low in the Mohs hardness (low hardness external additive) protects a surface of an electrophotographic image holding member (image holding member) and an external additive high in the Mohs hardness (high hardness external additive) strongly can polish a discharge product adhered on a surface of the electrophotographic image holding member to enable to apply cleaning while suppressing surface scratch and localized wearing that cause an image defect. The Mohs hardness is a value expressed by 1 to 15 in terms of new Mohs hardness.

The Mohs hardness of the low hardness external additive is, from the viewpoint of developing an advantage of protecting a surface of the electrophotographic image holding member, preferably from 2 to 6 or from about 2 to about 6, and more preferably from about 3 to about 5.

Furthermore, the Mohs hardness of the high hardness external additive is, from the viewpoint of exerting an advantage of strongly polishing a discharge product adhered to a surface of the electrophotographic image holding member, preferably about 7 to about 9, and more preferably about 7.5 to about 8.5.

Examples of preferable combinations of the low hardness external additive and the high hardness additive when two of external additives different in the Mohs hardness are contained include calcium carbonate and alumina, calcium sulfate and zirconia and calcium fluoride and silicon nitride.

A containing ratio of the low hardness external additive to the high hardness external additive (low hardness external additive:high hardness external additive, by weight ratio) is preferably from 20:80 to 80:20 or from about 20:80 to about 80:20, and more preferably from about 30:70 to about 70:30.

Furthermore, a total content of the external additives in the toner of the exemplary embodiment is, to 100 parts by weight of the toner, preferably 0.8 parts by weight to 3.5 parts by weight and more preferably 1 parts by weight to 2.5 parts by weight.

A volume average particle diameter D50v of the toner of the exemplary embodiment is preferably in a range of 3 μm to 7 μm. When the volume average particle diameter D50v is less than 3 μm, in some cases, the charging property becomes insufficient to cause scattering to the periphery to result in image fogging. On the other hand, when the D50v exceeds 7 μm, the resolution of an image is deteriorated to be difficult to achieve high image quality in some cases. The volume average particle diameter D50v is more preferably in a range of 5 μm to 6.5 μm.

Furthermore, a volume average particle size distribution index GSDv of the toner is preferably 1.28 or less or about 1.28 or less. When the GSDv exceeds about 1.28, in some cases, the sharpness and resolution of an image are deteriorated. On the other hand, a number average particle size distribution index GSDp is preferably 1.30 or less. When the GSDp exceeds 1.30, since a ratio of a smaller particle toner becomes high, in some cases, in addition to the initial performance, the reliability as well is largely adversely affected. That is, as well known for a long time, since the adhesion of smaller particle toner is larger, the electrostatic control becomes difficult, and, when a two-component developing agent is used, in some cases, the smaller particle toner tends to remain on the carrier. In this case, when the mechanical force is repeatedly applied, in some cases, the carrier contamination is caused to result in accelerating the deterioration of the carrier.

In particular in the transfer step, among toners developed on an image holding member, a smaller particle component tends to be difficult to transfer to result in deteriorating the transfer efficiency to result in an increase in waste toner or occurrence of the image defect in some cases. As the result of the problems, the toners that are not electrostatically controlled or toners having opposite polarity increase to contaminate the periphery in some cases. In particular, since the toners that are not controlled are accumulated through the image holding member on a charging roll, in some cases, charging defect is caused.

Furthermore, since the toner of the small particle component tends to be insufficient in the inclusivity of the crystalline resin, in some cases, the filming to the image holding member is caused. On the other hand, in the toner of a larger particle component as well, in some cases, the toner cracking in the developing device, spouting from the developing device or the image quality deterioration due to charging defect is caused.

The volume average particle size distribution index GSDv is more preferably 1.25 or less and the number average particle size distribution index GSDp is more preferably 1.25 or less.

Herein, the volume average particle diameter D50v and various kinds of particle size distribution indices may be measured by use of Multisizer II (trade name, manufactured by Beckmann-Coulter, Inc.) with ISOTON-II (trade name, manufactured by Beckmann-Coulter, Inc.) as an electrolyte.

At the time of measurement, in 2 ml of a 5% by weight aqueous solution of a surfactant as a dispersing agent such as sodium alkylbenzene sulfonate, a measurement sample is added in a range of 0.5 mg to 50 mg. This is added to 100 ml to 150 ml of electrolyte.

The electrolyte in which a sample is suspended is dispersed for 1 min by use of an ultrasonic disperser and a particle size distribution of particles in a range of 2 μm to 50 μm is measured by use of the Multisizer II with an aperture having an aperture diameter of 100 μm. The number of sampled particles is 50,000.

Based on thus measured particle size distributions, to divided particle size ranges (channels), cumulative distributions of volumes and numbers, respectively, are depicted from a smaller particle diameter side, and, particle diameters at 16% cumulation are defined as the cumulative volume average particle diameter D16v and cumulative number average particle diameter D16p, particle diameters at 50% cumulation are defined as the cumulative volume average particle diameter D50v and cumulative number average particle diameter D50p and particle diameters at 84% cumulation are defined as the cumulative volume average particle diameter D84v and cumulative number average particle diameter D84p.

Herein, the volume average particle size distribution index (GSDv) and number average particle size distribution index (GSDp), respectively, are defined as (D84v/D16v)^{1/2} and (D84p/D16p)^{1/2}.

Furthermore, the average circularity of the toners is preferably in a range of 0.940 to 0.980 or in a range of about 0.940 to about 0.980. When the average circularity is less than the range, a shape becomes more amorphous to, in some cases, deteriorate the transfer property, durability and fluidity. On the other hand, when the circularity exceeds the range, a ratio of spherical particles becomes larger to result in, in some cases, difficulty in the cleaning property. The average circularity is more preferably in a range of 0.950 to 0.970.

In the case of a toner that contains a crystalline resin, since the average circularity is on a sphere side (where the average circularity is close to 1), that is, spherical toners abundant in a crystalline resin component tend to increase to result in, in some cases, the filming due to accumulation at a contact portion with a cleaning member, member deterioration due to a rise in torque or the filming to the image holding member. On the other hand, when the circularity is on an amorphous side (where the average circularity is close to zero), the toner may be cracked in a developing device and in some cases, on a cracked interface, a crystalline resin component is exposed to damage the chargeability.

The average circularity of the toner particles may be measured by use of a flow-type particle image analyzer FPIA-2000 (trade name, manufactured by Toa Iyo Denshi K. K.). As a specific measurement method, in 100 ml to 150 ml of water from which an impure solid content is removed in advance, as a dispersing agent, 0.1 ml to 0.5 ml of a surfactant such as alkylbenzene sulfonate is added, followed by adding substantially 0.1 g to 0.5 g of a measurement sample.

A suspension in which a measurement sample is dispersed is subjected to dispersing treatment by an ultrasonic dispersing device for 1 min to 3 min, a concentration of the dispersion is controlled to 3,000 pieces/μl to 10,000 pieces/μl, and the average circularity of the toner particles is measured by use of the above device.

The glass transition temperature Tg of the toner of the exemplary embodiment is not particularly restricted but selected preferably in a range of 45° C. to 60° C. When the glass transition temperature is less than the range, in some cases, the storage property of the toner, the storage property of fixed image, or the durability in an actual machine may be problematic. On the other hand, when the glass transition temperature is higher than the range, in some cases, there are problems in that the fixing temperature becomes higher and a temperature necessary for granulation becomes higher.

The Tg is measured by use of a DSC meter (trade name: DIFFERENTIAL SCANNING CALORIMETER DSC60A, manufactured by Shimadzu Corporation) in accordance with ASTMD 3418-8. When a temperature correction of a detector of a device is carried out, melting points of indium and zinc are used and, in a calorie correction, the melting heat of indium is used. As a sample, an aluminum pan is used, and, with a blank pan set as a reference, a measurement is carried out at a temperature-up speed of 10° C./min.

A charging amount of the toner for electrostatic charge image development of the exemplary embodiment is, by an absolute value, preferably in a range of 10 μC/g to 40 μC/g, and more preferably in a range of 15 μC/g to 35 μC/g. When the charging amount is less than 10 μC/g, the contamination of a background portion tends to occur and, when the charging amount exceeds 40 μC/g, in some cases, the image density tends to be lower.

Furthermore, a ratio of the charging amount of the toner for electrostatic charge image development in summer (28° C. and 85% RH) relative to that in winter (10° C. and 30% RH) is preferably from 0.5 to 1.5, and more preferably from 0.7 to 1.3. When the ratio is outside of the range, the environmental dependency of the toner becomes stronger to be deficient in the stability of the charging property to result in, in some cases, being practically unfavorable.

### —Producing Method of Toner—

Next, a producing method of a toner of the exemplary embodiment will be described.

A toner of the exemplary embodiment is preferably produced by unit of an emulsion polymerization aggregation method that includes a colorant dispersing step for dispersing a colorant, a colorant dispersion preparation step where a chelate dispersion is poured to the dispersed colorant, followed by mixing and agitating to prepare a colorant dispersion, an aggregated particle forming step where a resin fine particle dispersion in which resin fine particles are dispersed and the colorant dispersion are mixed to form aggregated particles and a fusing and coalescing step where the aggregated particles are heated to a temperature equal to or higher than the glass transition temperature of the resin fine particles (or a melting point of a crystalline resin) to fuse and coaleace.

Furthermore, the toner of the exemplary embodiment, as far as it has the colorant dispersion preparation step, may be produced by a so-called wet process. Other than the emulsion polymerization aggregation method, a suspension polymerization method where a component used as needs arise such as a releasing agent or a colorant is suspended together with a polymerizable monomer that forms a binder resin such as a crystalline resin to polymerize the polymerable monomer and a dissolution suspension method where toner constituting materials such as a compound having an ionic dissociation group, a binder resin such as a crystalline resin and a releasing agent are dissolved in an organic solvent, followed by dispersing in an aqueous solvent in a suspended state, further followed by removing the organic solvent may be used to produce.

When the emulsion polymerization aggregation method is utilized, other dispersions such as an inorganic particle dispersion and a resin particle dispersion where a non-crystalline resin is dispersed may be added. In particular, when a dispersion of inorganic particles of which surface is hydrophobicized is added, depending on the degree of the hydrophobicization, the dispersibility of a releasing agent and a crystalline resin inside of the toner may be controlled.

In what follows, a producing method by steps the emulsion polymerization aggregation method of the toner of the exemplary embodiment will be detailed as a specific example.

When the toner of the exemplary embodiment is produced according to an emulsion polymerization aggregation method, as mentioned above, the toner is produced through at least an aggregated particle forming step and a fusing and coalescing step. However, an adhesion step where, on a surface of an aggregated particle (core particle) formed via the aggregated particle forming step, resin particles are adhered to form aggregated particles having a core/shell structure may be added.

### —Aggregated Particle Forming Step—

In the aggregated particle forming step, in a raw material dispersion where, in addition to the colorant dispersion prepared in the colorant dispersing step and colorant dispersion preparation step and the resin particle dispersion where a crystalline resin or the like are dispersed, as needs arise, other dispersion such as a releasing agent dispersion where a releasing agent is dispersed is mixed, aggregated particles are formed.

Specifically, a raw material dispersion obtained by mixing various dispersions is heated to form aggregated particles where particles in the raw material dispersion are aggregated. Herein, the raw material dispersion is heated in a temperature region that is lower than the melting point (a temperature lower by 20° C. to 10° C. than the melting point) of the crystalline resin.

Aggregated particles are formed when, under agitation by use of a rotary shearing homogenizer, a flocculant is added specifically at a temperature from 20° C. to 30° C. and the pH of the raw material dispersion is made acidic.

As a flocculant used in the aggregated particle forming step, a surfactant having the polarity opposite to that of a surfactant used as a dispersing agent added to the raw material dispersion, that is, other than an inorganic metal salt, a metal complex containing a metal element capable of having a valency of two or more is preferably used. In particular, when the metal complex is used, a usage amount of the surfactant is reduced to be able to particularly preferably improve the charging characteristics.

Examples of the inorganic metal salts include metal salts such as calcium chloride, calcium nitrate, barium chloride, magnesium chloride, zinc chloride, aluminum chloride or aluminum sulfate and polymers of inorganic metal salt such as polyaluminum chloride, polyaluminum hydroxide or calcium polysulfide. Among these, an aluminum salt and a polymer thereof are particularly preferred. In order to obtain a sharper particle size distribution, a valence of the inorganic metal salt is preferred to be divalent to monovalent, trivalent to divalent and tetravalent to trivalent and, when the valence is the same, a polymerization type inorganic metal salt polymer is more suitable.

It is preferred to add an inorganic particle dispersion obtained from the inorganic metal salt to simultaneously flocculate. Thereby, the inorganic metal salt effectively works on a molecular chain terminal of a binder resin to be able to contribute to formation of a crosslinking structure.

The inorganic particle dispersion is prepared by use of an arbitrary method such as a ball mill, a sand mill, a supersonic dispersing device or a rotary shearing type homogenizer and a dispersion average particle diameter of inorganic particles is preferably set in a range of 100 nm to 500 nm.

In the aggregated particle forming step, an inorganic particle dispersion may be added either in a stepwise manner or in a continuous manner. The methods are effective for uniformly dispersing the metal ion component in the inorganic particle dispersion from a surface to the interior of the toner. It is particularly preferable that, when the dispersion is added in a stepwise manner, the dispersion is added at three or more stages and that, when the dispersion is added in a continuous manner, the dispersion is added at a slow speed such as substantially 0.1 g/m or less.

An amount of the inorganic particle dispersion added is, though varying depending on a metal that is needed and an extent of formation of a crosslinked structure, preferably in a range of substantially 0.5 parts by weight to 10 parts by weight and more preferably in a range of substantially 1 parts by weight to 5 parts by weight, based on I 00 parts by weight of the binder resin component.

In the aggregated particle forming step, when, within a range that does not adversely affect on the formation of aggregated particles, types or usage amounts of an inorganic metal salt containing a metal element that can have a valency of two or more or a metal complex are controlled, a content of a metal element that can have a valency of two or more and is contained in the toner mother particle may be controlled.

From the viewpoint of readily enabling to combine the low temperature fixability and the uneven gloss suppressing effect at a high level, among the cited flocculants, aluminum sulfate, polyaluminum chloride or calcium chloride is preferably used.

### —Adhesion Step—

After the aggregated particle forming step, as needs arise, an adhesion step may be carried out. In the adhesion step, resin particles are allowed to adhere on a surface of aggregated particles formed through the aggregated particle forming step to form a coat layer. Thereby, a toner having a core/shell structure that has a so-called core layer and a shell layer that coats the core layer may be obtained.

The coat layer may be formed by additionally adding a resin particle dispersion usually containing non-crystalline resin particles into a dispersion where aggregated particles (core particles) are formed in the aggregated particle forming step. In the case where in the aggregated particle forming step, other than a crystalline resin, a non-crystalline resin is used together, the non-crystalline resin used in the adhesion step may be the same as or different from the one used in the aggregated particle forming step.

In general, the adhesion step is used in preparing a toner having a so-called core/shell structure wherein together with the releasing agent, the crystalline resin as binder resin is contained as a main component, and the major object thereof is to inhibit the releasing agent or crystalline resin contained in the core layer from exposing on a toner surface, or to compensate for the strength of toner particles which may be insufficient when the toner particles are made of the core alone.

### —Fusing and Coalescing Step—

The fusing and coalescing step, which is carried out after the aggregated particle forming step or after both the aggregated particle forming step and adhesion step, includes: adjusting a pH of the suspension containing aggregated particles formed through these steps to be in a desired range so as to terminate progress of the aggregating; and heating so as to fuse the aggregated particles.

Adjusting of the pH is performed by adding an acid and/or an alkali. While the acid is not particularly limited, an aqueous solution containing about 0.1% by weight to about 50% by weight of an inorganic acid such as hydrochloric acid, nitric acid, sulfuric acid or the like is preferable.

While the alkali is not particularly limited, an aqueous solution containing about 0.1 to 50% of an alkali metal hydroxide such as sodium hydroxide, potassium hydroxide or the like is preferable.

In adjusting the pH, when a local change in the pH occurs, local destruction of an aggregated particle itself or local excessive aggregation is caused, and the change leads to deterioration in a shape distribution. Particularly, as a scale becomes large, an amount of an acid and/or an alkali is increased. Generally, since the acid and the alkali are introduced at one place, when treatment is performed at the same time, a concentration of the acid and the alkali becomes higher at a larger scale.

After the composition control is performed, aggregated particles are fused by heating. In the fusing, the aggregated particles are fused by heating at a temperature which is higher by 10° C. to 30° C. than a glass transition temperature of the crystalline resin (when a non-crystalline resin is used, at a temperature higher than by 10° C. to 30° C. than a glass transition temperature of the non-crystalline resin).

When heating is carried out for fusing or after the fusing is completed, crosslinking may be carried out. Crosslinking may be alternatively carried out simultaneously the fusing. When crosslinking is carried out, the crosslinking agent and polymerization initiator described above are used in preparation of the toner.

The polymerization initiator may be mixed with the dispersion before the stage of preparing the starting dispersion or may be incorporated into the aggregated particles in the aggregated particle forming step. Alternatively, the polymerization initiator maybe introduced during the fusing and coalescing step or after the fusing and coalescing step. When the polymerization initiator is introduced during the aggregated particle forming step, during the adhesion step, during the fusing and coalescing step or after the fusing and coalescing step, a solution or emulsion of the polymerization initiator is added to the dispersion. For the purpose of regulating the degree of polymerization, a known crosslinking agent, chain transfer agent, polymerization inhibitor or the like. may be added to the polymerization initiator.

### —Washing Step, Drying Step and the Like—

After the fusing and coalescing step of the aggregated particles is completed, desired toner particles (toner mother particles) are obtained through arbitrary washing, solid/liquid separating and drying. In consideration of charging properties, the washing preferably sufficiently conducted by replacement washing using ion-exchanged water. While the solid/liquid separating is not particularly limited, from the viewpoint of productivity, filtration under suction, filtration under pressure and the like are preferable. Further, while the drying is not particularly limited, from the viewpoint of productivity, freeze drying, flash jet drying, fluidizing drying, vibration fluidizing drying and the like are preferable. Various external additives described above can be added to the toner particles (toner mother particles) after drying in accordance with necessity.

### <Electrophotographic Developing Agent>

The electrophotographic developing agent of the exemplary embodiment (hereinafter, in some case, referred to as “developing agent of the exemplary embodiment”) contains the toner of the exemplary embodiment, and may further contain other components in accordance with objects.

Specifically, when the toner of the exemplary embodiment is used singularly, the developing agent of the exemplary embodiment is prepared as a one-component electrophotographic developing agent, and when the toner is used in combination with a carrier, the developing agent is prepared as a two-component electrophotographic developing agent. A concentration of the toner is preferably in a range of 1% by weight to 10% by weight.

The carrier is not particularly restricted, known carriers are cited and examples thereof include known carriers such as a carrier having a core material coated with a resin layer (resin-coated carrier), which is described in JP-A Nos. 62-39879 and 56-11461.

Examples of the core material of the resin-coated carrier include shaped products of iron powder, ferrite or magnetite, and an average particle diameter of the core material is in a range of substantially 30 μm to 200 μm.

Examples of the coating resin that forms the coat layer includes styrenes such as styrene; parachlorostyrene or α-methylstyrene, α-methylene aliphatic monocarboxylic acids such as methyl acrylate, ethyl acrylate, n-propyl acrylate, lauryl acrylate, 2-ethylhexyl acrylate, methyl methacrylate, n-propyl methacrylate, lauryl methacrylate or 2-ethylhexyl methacrylate; nitrogen-containing acryls such as dimethylaminoethyl methacrylate, vinyl nitrites such as acrylonitrile or methacrylonitrile, vinyl pyridines such as 2-vinyl pyridine or 4-vinyl pyridine, vinyl ethers such as vinyl methyl ether or vinyl isobutyl ether, vinyl ketones such as vinyl methyl ketone, vinyl ethyl ketone or vinyl isopropenyl ketone, olefins such as ethylene or propylene, homopolymers of vinyl-based fluorine-containing monomers such as vinylidene fluoride, tetrafluoroethylene or hexafluoroethylene, or copolymers consisting of two or more monomers, silicones such as methylsilicone or methylphenylsilicone; polyesters containing bisphenol or glycol, epoxy resin, polyurethane resin, polyamide resin, cellulose resin, polyether resin and polycarbonate resin. These resins may be used singularly or as a mixture of two or more of them.

An amount of the coating resin is preferably in a range of 0.1 parts by weight to 10 parts by weight, and more preferably in a range of 0.5 parts by weight to 3.0 parts by weight, with respect to 100 parts by weight of the core material. For production of the carrier, a heating kneader, a heating Henschel mixer, an UM mixer or the like may be used, and a heating fluidized rolling bed, a heating kiln or the like may be used depending on the amount of the coating resin. A mixing ratio of the toner/carrier in the electrophotographic developing agent is not particularly restricted and may be suitably selected depending on the purpose.

### <Image Forming Method, Image Forming Apparatus, Toner Cartridge and Process Cartridge>

Next, an image forming method that uses a developing agent of the exemplary embodiment will be described.

As an image forming method that uses a toner of the exemplary embodiment, a known electrophotographic method can be utilized. Specifically, the image forming method preferably includes an electrostatic latent image forming step where on a surface of an image holding member an electrostatic latent image is formed, a toner image forming step where the electrostatic latent image is developed by a developing agent containing a toner to form a toner image, a transfer step where the toner image is transferred on a recording medium and a fixing step where the toner image is fixed on the recording medium.

The image forming method of the exemplary embodiment may be combined with, other than the steps, known steps usable in image forming method by electrophotography, that is, the method may further include, for example, a cleaning step where applying cleaning while recovering residual toner remaining on the surface of the image holding member after the transfer step, or a toner recycle step where the toner recovered in the cleaning step is re-used (recycled) as the toner for a developing agent.

Herein, the electrostatic latent image forming step is a step where, after charging an image holding member surface with a charging unit, an image holding member is exposed with a laser optical system or an LED array to form an electrostatic latent image. Examples of charging unit include non-contact-type charging devices such as corotron and scorotron and contact-type charging devices that charge an image holding member surface by applying a voltage to an electrically conductive member in contact with the image holding member surface. Any one of these may be used. However, from the viewpoints of exerting the effects of less generation of ozone, environmental compatibility and excellent printing resistance, a contact-type charging device is preferable. In the contact-type charging device, a shape of the electrically conductive member, without restricting particularly, may be any one of a brush-shape, blade-shape, pin electrode-shape or roller-shape. The latent image forming step is not restricted only to the above embodiments.

The toner image forming step is a step where a developing agent holder on a surface of which a developing agent layer containing at least a toner is formed is brought into contact with or brought close to an image holding member surface to make toner particles adhere to an electrostatic latent image on the image holding member surface to form a toner image on the image holding member surface. Known systems may be used in the developing system, and examples of a developing system where the developing agent is a two-component developing agent include a cascade system and a magnetic brush system. The developing system is not restricted only to the above embodiment.

The transfer step is a step where the toner image formed on the image holding member surface is transferred onto a recording medium. The transfer step may be, other than a system where a toner image is transferred directly on a recording medium such as paper, a system where, after the toner image is transferred on a drum-shaped or belt-shaped intermediate transfer body, the toner image is transferred on a recording medium such as paper. The transfer system is not restricted only to the aspects.

A corotron may be used as a transferring device for transferring the toner image from the image holding member on paper or the like. The corotron is effective as unit for charging paper. However, in order to apply predetermined charge to paper as a recording medium, a voltage such high as several kV has to be applied; accordingly, a high-voltage power source is necessary. Furthermore, because ozone is generated due to corona discharge, rubber parts and the image holding member are deteriorated. Accordingly, a contact-transfer system is preferable in which an electrically conductive transfer roll made of an elastic material is brought into contact with the image holding member under pressure to transfer the toner image on paper. The transfer device is not restricted only to the above embodiment.

The cleaning step is a step where a blade, brush or roll is brought into direct contact with an image holding member surface to remove a toner, paper powder and dust adhering to the image holding member surface.

The most generally used system is a blade cleaning system wherein a blade made of rubber such as polyurethane is brought into contact with the image holding member under pressure. On the other hand, a magnetic brush system where a magnet is fixed inside, a rotatable cylindrical non-magnetic sleeve is disposed in the outer periphery of the magnet, and a magnetic carrier is held on the surface of the sleeve to recover a toner, or a system where a semi conductive resin fiber or animal hair is formed into a roll to enable to rotate, and a bias of polarity opposite to the toner is applied to the roll to remove the toner may be used. In the former magnetic brush system, a corotron for cleaning pretreatment may be disposed. In the cleaning system is not restricted only to the above embodiment.

The fixing step is a step where the toner image transferred on the surface of the recording medium is fixed with a fixing unit. As the fixing unit, a heating fixing device using a heat roll is preferably used. The heating fixing device includes a fixing roller that has a heater lamp for heating inside of a cylindrical metallic core and is provided with a so-called releasing layer formed from a heat-resistant resin coating layer or a heat-resistant rubber coating layer on the outer periphery surface thereof, and a press roller or a press belt disposed in contact with the fixing roller under pressure and having a layer containing a heat-resistant elastic material formed on the outer periphery surface of a cylindrical metallic core or on a surface of a belt-shaped substrate. In the fixing process of a toner image, a recording medium having the toner image formed thereon is passed through a contact portion formed between the fixing roller and the press roller or the press belt to fix by heat melting the binder resin and additives in the toner. The fixing system is not restricted only to the above embodiment.

In the case of preparing a full-color image, a plurality of image holding members, respectively, has a developing agent holder of each of the respective colors. In the case, an image forming method where, by a series of steps including a latent image forming step, a toner image forming step, a transfer step and a cleaning step, on a surface of the same recording medium, for each of the steps, a toner image of each of colors is sequentially superposed and formed, and the superposed full-color toner image is heat-fixed in the fixing step is preferably used.

When the developing agent of the exemplary embodiment is used in the image forming method, stable development, transfer and fixing performance may be obtained even in a tandem system that is down-sized and appropriate for high-speed color printing.

An image forming apparatus of the exemplary embodiment is characterized in that it includes at least: an image holding member; a charging unit for charging a surface of the image holding member; an electrostatic latent image forming unit for forming an electrostatic latent image on a surface of the charged image holding member; a toner image forming unit for forming a toner image by developing the electrostatic latent image with a developing agent; a transfer unit for transferring the toner image on a recording medium surface; a fixing unit for fixing the toner image transferred on the recording medium surface; and a cleaning unit for removing a toner remaining on the surface of the image holding member after transferring, the developing agent being a developing agent of the exemplary embodiment. The image forming apparatus of the exemplary embodiment uses a developing agent of the exemplary embodiment; accordingly, a high quality image can be formed over a long term.

The image forming apparatus of the exemplary embodiment will be described with reference to the drawings.

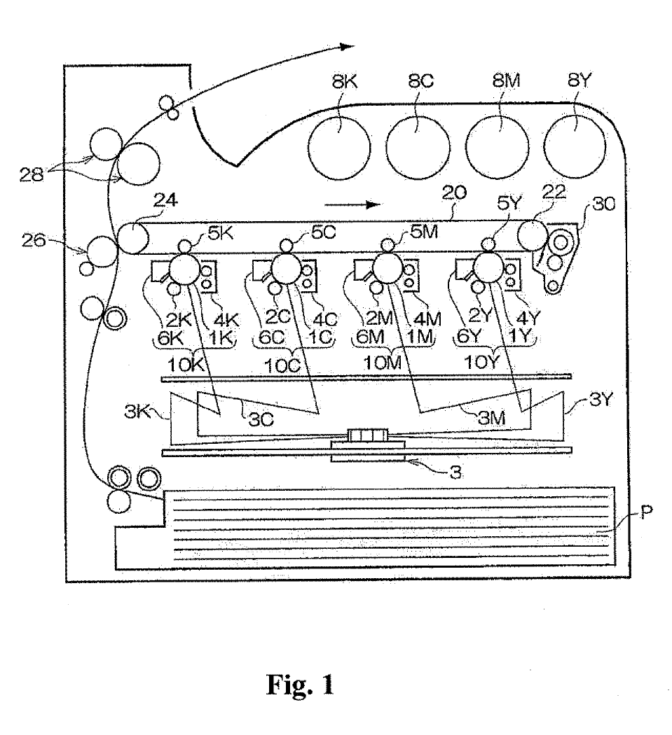

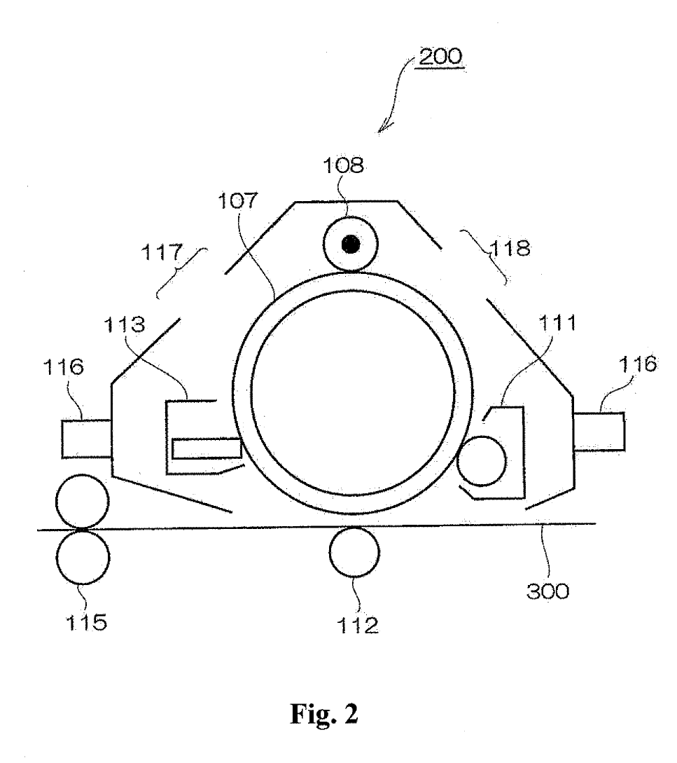

In FIG. 1 and FIG. 2, 1Y, 1M, 1C, 1K, and 107 are each a photoreceptor (image holding member). 2Y, 2M, 2C, 2K, and 108 are each a charging roller. 3Y, 3M, 3C and 3K are each laser beam. 3 is an exposing unit. 4Y, 4M, 4C, 4K and 111 are each a developing unit (developing part). 5Y, 5M, 5C, and 5K are each a first transfer roller. 6Y, 6M, 6C, 6K, and 113 are each photoreceptor cleaning unit (cleaning part). 8Y, 8M, 8C, and 8K are each a toner cartridge. 10Y, 10M, 10C and 10K are each a unit. 20 is an intermediate transfer belt. 22 is a drive roller. 24 is a supporting roller. 26 is a second transfer roller (transfer part). 28 and 115 are each a fixing unit (fixing part). 30 is an intermediate transfer body cleaning device. 112 is a transfer unit. 116 is a attaching rail. 117 is an opening for discharging exposure. 118 is an opening for exposure. 200 is a process cartridge. P and 300 are each a recording paper (recording medium).

FIG. 1 is a schematic block diagram showing one example of an image forming apparatus of the exemplary embodiment. The image forming apparatus shown in FIG. 1 is a four tandem full-color image forming apparatus and includes electrophotographic first to fourth image forming units 10Y, 10M, 10C and 10K that output images of the respective colors of yellow (Y), magenta (M), cyan (C) and black (K) based on color separated image data. The image forming units (hereinafter, simply referred to as “unit”) 10Y, 10M, 10C and 10K are arranged in a parallel in the horizontal direction at a predetermined distance apart from each other. The units 10Y, 10M, 10C and 10K each may be a process cartridge detachable from the main body of the image forming apparatus.

In an upper side in the drawing of the respective units 10Y, 10M, 10C and 10K, an intermediate transfer belt 20 as an intermediate transfer body is disposed extended through the respective units. The intermediate transfer belt 20 is disposed wound around a drive roller 22 and a support roller 24, which are disposed separated from each other from left to right in the drawing and in contact with an interior surface of the intermediate transfer belt 20, and runs in a direction from the first unit 10Y to the fourth unit 10K. The support roller 24 is energized in a direction departing from the driving roller 22 by a spring or the like that is not shown in the drawing to impart predetermined tension to the intermediate transfer belt 20 wound around the both. On an image holding member side surface of the intermediate transfer belt 20, an intermediate transfer body cleaning unit 30 is disposed opposite to the driving roller 22.

Furthermore, to the respective developing units (developing part) 4Y, 4M, 4C and 4K of the respective units 10Y, 10M, 10C and 10K, toners of four colors of yellow, magenta, cyan and black, which are stored in toner cartridges 8Y, 8M, 8C and 8K, may be supplied.

The first to fourth units 10Y, 10M, 10C and 10K have an identical configuration. Accordingly, as a representative thereof, the first unit 10Y that is disposed on an upstream side in a running direction of the intermediate transfer belt and forms a yellow image will be described. In portions identical as that of the first unit 10Y, in place of yellow (Y), reference marks provided with magenta (M), cyan (C) and black (K) are imparted to omit descriptions of the second to fourth units 10M, 10C and 10K.

The first unit 10Y has a photoreceptor 1Y that works as an image holding member. Around the photoreceptor 1Y, a charging roller 2Y that charges a surface of the image holding member 1Y to a predetermined potential; an exposure unit 3 that exposes a charged surface using a laser beam 3Y based on color separated image signals to form an electrostatic charge image; a developing unit (developing part) 4Y that supplies a charged toner to the electrostatic charge image to develop the electrostatic charge image; a first transfer roller 5Y (first transfer unit) that transfers the developed toner image on the intermediate transfer belt 20; and a photoreceptor cleaning unit 6Y that removes the toner remaining on a surface of the photoreceptor 1Y after the first transfer are sequentially disposed.

The first transfer roller 5Y is disposed inside of the intermediate transfer belt 20 and at a position that faces the photoreceptor 1Y. Furthermore, to the respective first transfer rollers 5Y, 5M, 5C and 5K, bias supplies (not shown) that apply a first transfer bias are connected respectively. Each of the bias power supplies varies a transfer bias applied to each of the first transfer rollers by a not shown control portion.

In what follows, an operation by which a yellow image is formed in the first unit 10Y will be described. In the beginning, ahead of the operation, a surface of a photoreceptor 1Y is charged to a potential of substantially −600 V to −800 V by use of a charging roller 2Y.

The photoreceptor 1Y is formed by laminating a photosensitive layer on an electrically conductive (volume resistivity at 20° C.: 1×10⁻⁶ Ωcm or less) substratel. The photosensitive layer is usually in a high resistance state (the resistance to an extent of general resins). However, when a laser beam 3Y is irradiated, the specific resistance of a portion that is irradiated by the laser beam varies. There, on a surface of a charged photoreceptor 1Y, in accordance with yellow image data transmitted from a not shown controller, the laser beam 3Y is outputted through an exposing unit 3. The laser beam 3Y is irradiated on a photosensitive layer on a surface of the photoreceptor 1Y, and, thereby, an electrostatic charge image of a yellow printing pattern is formed on a surface of the photoreceptor 1Y.

An electrostatic charge image is an image formed on a surface of the photoreceptor 1Y by charging and a so-called negative latent image formed in such a manner that, when the laser beam 3Y is irradiated, the specific resistance of an irradiated portion of the photosensitive layer is lowered to allow electric charges charged on a surface of the photoreceptor 1Y to flow, on the other hand, electric charges of a portion that is not irradiated with the laser beam 3Y remain.

The electrostatic charge image formed thus on the photoreceptor 1Y is rotated to a predetermined developing position owing to running of the photoreceptor 1Y. Then, at the developing position, the electrostatic charge image on the photoreceptor 1Y is visualized (developed) by a developing unit 4Y.

In the developing unit 4Y, for instance, a yellow toner that contains at least a yellow colorant, a crystalline resin and a non-crystalline resin and has a volume average particle diameter of 7 μm is stored. The yellow toner is, when agitated inside of the developing unit 4Y, tribocharged and retained on a developing agent roll (developing agent holder) with electric charges of the polarity (negative polarity) same as that of electric charges charged on the photoreceptor 1Y. Then, when a surface of the photoreceptor 1Y goes past the developing unit 4Y, on a neutralized latent image portion on a surface of the photoreceptor 1Y, the yellow toner is electrostatically adhered to develop a latent image by the yellow toner. The photoreceptor 1Y on which the yellow toner image is formed is conveyed on at a predetermined speed and thereby a toner image developed on the photoreceptor 1Y is transported to a predetermined first transfer position.

When the yellow toner image on the photoreceptor 1Y is conveyed to a first transfer position, a predetermined first transfer bias is applied to a first transfer roller 5Y, thereby an electrostatic force directing from the photoreceptor 1Y to the first transfer roller 5Y is operated to a toner image to transfer the toner image on the photoreceptor 1Y on an intermediate transfer belt 20. The transfer bias applied at this process has (+) polarity opposite to the polarity (−) of the toner and, for instance, the first unit 10Y is controlled to substantially +10 μA by a controller (not shown).

On the other hand, the toner remained on the photoreceptor 1Y is removed and recovered by a cleaning unit 6Y.

Furthermore, first transfer biases applied to the first transfer rollers 5M, 5C and 5K after the second unit 10M as well are controlled in accordance with the first unit.

Thus, the intermediate transfer belt 20 on which the yellow toner image was transferred at the first unit 10Y is conveyed sequentially through the second to the fourth units 10M, 10C and 10K, and thereby toner images of the respective colors are superposed to carry out multiple transfer.

The intermediate transfer belt 20 on which toner images of four colors are plurally transferred through the first to the fourth units reaches a second transfer portion that is constituted of the intermediate transfer belt 20, a support roller 24 in contact with an interior surface of the intermediate transfer belt 20 and a second transfer roller (second transfer unit) 26 disposed on a side of an image holding surface of the intermediate transfer belt 20. On the other hand, a recording paper (recording medium) P is fed at a predetermined timing through a feeding unit to a gap where the second transfer roller 26 and the intermediate transfer belt 20 are brought into contact under pressure and a predetermined second transfer bias is applied to the support roller 24. A transfer bias applied at this process has a (−) polarity same as the polarity (−) of the toner and thereby an electrostatic force directing from the intermediate transfer belt 20 to the recording paper P is operated on the toner image to transfer the toner image on the intermediate transfer belt 20 on the recording paper P. The second transfer bias at this process is determined depending on the resistance detected by resistance detecting unit (not shown) that detects the resistance of the second transfer portion and controlled by a voltage.

Thereafter, the recording paper P is conveyed to a fixing unit (fixing part) 28 to heat the toner image, thereby, the color-superposed toner image is melted and fixed on the recording paper P. The recording paper P where a color image has been fixed thereon is conveyed to an exit portion and thereby a series of color image forming operation is completed.

In the exemplified image forming apparatus, through the intermediate transfer belt 20, the toner image is transferred on the recording paper P. However, the image forming apparatus, without restricting to the configuration, may have a structure where a toner image is directly transferred from the image holding member to the recording paper.

A process cartridge of the exemplary embodiment characterized in that it is detachable to an image forming apparatus and includes at least an image holding member and a toner image forming unit that stores a developing agent and supplies the developing agent on an electrostatic latent image formed on the image holding member surface to form a toner image, wherein the developing agent is the developing agent of the exemplary embodiment.

FIG. 2 is a schematic constitutional diagram showing one preferable example of a process cartridge that stores a developing agent of the exemplary embodiment. A process cartridge 200 is formed by combining and integrating, by use of an attaching rail 116, together with a photoreceptor (image holding member) 107, a charging roller 108, a developing unit 111, a photoreceptor cleaning unit 113, an opening 118 for exposure and an opening 117 for neutralization exposure.

The process cartridge 200 is constituted detachable to an image forming apparatus body that includes a transfer unit 112, a fixing unit 115 and not shown other constituent portion and constitutes an image forming apparatus together with the image forming apparatus body. Here, reference numeral 300 expresses recording paper (recording medium).

A process cartridge shown in FIG. 2 includes a charging unit 108, a developing unit 111, a cleaning unit (cleaning unit) 113, an opening 118 for exposure and an opening 117 for neutralization exposure. However, these units may be selectively combined. The process cartridge of the invention includes, other than the photoreceptor 107, at least one kind selected from a group consisting of a charging unit 108, a developing unit 111, a cleaning unit (cleaning unit) 113, an opening 118 for exposure and an opening 117 for neutralization exposure.

A toner cartridge of the exemplary embodiment is detachable to an image forming apparatus provided with at least toner image forming unit and stores a developing agent containing a toner for supplying to the toner image forming unit, the toner being a toner of the exemplary embodiment. It is enough that the toner cartridge of the exemplary embodiment stores at least a toner and, depending on a mechanism of the image forming apparatus, may store, for instance, a developing agent.

Accordingly, in an image forming apparatus having a configuration capable of detaching a toner cartridge, when a toner cartridge that stores the toner of the invention is used, in particular even in a toner cartridge of which size is downsized, the storability can be maintained and while maintaining a high image quality the low temperature fixing can be achieved.

An image holding member used in a toner cartridge, a process cartridge and an image forming apparatus of the exemplary embodiment is an electrophotographic photoreceptor having the outermost surface layer, and an oxygen permeability of the outermost surface layer is preferred to be about 2,500 fm/s·Pa or less.

An oxidized and degraded material that is problematic when it adheres to a surface of a high durability photoreceptor is considered generated when for instance NOx or ozone gas penetrates inside of a photosensitive layer to chemically deteriorate a part of the photosensitive layer. Accordingly, the more difficult gas permeation of the outermost surface layer is, that is, the smaller the oxygen permeability is, the more difficult the generation of the oxidized and degraded material is to be advantageous in high image quality and longer lifetime. Furthermore, when the toner of the exemplary embodiment is used, the toner is inhibited from adhering to a photoreceptor surface.

A more preferable range of the oxygen permeability of the outermost surface layer is 2,000 fm/s·Pa or less and still more preferably 1,500 fm/s·Pa or less.

The oxygen permeability expresses an extent of easiness when an oxygen gas permeate the layer. When a different gas is used, an absolute value of the permeability is different. However, an order of the magnitudes of the oxygen permeabilitys hardly varies between layers that are samples; accordingly, the oxygen permeability may be construed as a measure expressing the easiness of the gas permeation. Since the oxygen permeability is a measure of the easiness of gas permeation, from a different viewpoint, it may be considered also as alternative characteristics of a physical gap rate of a layer. In the exemplary embodiment, the oxygen permeability is a value obtained as shown below. A sample film is set between hermetically sealed cells, both cells are evacuated, oxygen is encapsulated at predetermined pressure (such as 100 kPa) in one cell, and an amount of oxygen permeated through a sample film is read as a pressure value by a pressure sensor set to the other cell and converted into an oxygen amount.

Now, with the advent of recent high-speed apparatus, as mentioned above, the four tandem drum type image forming apparatus is in general use. In this type of apparatus, since each of the drums is provided with a cleaning device, when making a simple comparison with an existing one drum type apparatus, the toner that reaches the cleaning device without being transferred becomes one fourth. When the cleaning device has a blade particularly, since a reduction effect of friction force between a photoreceptor and the blade due to the toner is much reduced, both the blade and photoreceptor tend to be accelerated in the deterioration. By contrast, according to an image forming apparatus of the exemplary embodiment, even in the four tandem drum type image forming apparatus, wear of the photoreceptor and deterioration of the cleaning member are made sufficiently small and thereby a high quality image may be formed over a long term; accordingly, high-speed image formation is effectively realized.

Furthermore, recently, from the viewpoint of obtaining higher image quality, the toner small in the particle diameter, uniform in the particle size distribution and excellent in the conglobation tends to be used. When such toner is used, in order to secure the cleaning ability, an external additive is used. The image forming apparatus of the exemplary embodiment is preferably used when such toner containing the external additive is used. This is because, by using such toner, due to repetition use, the external additive is accumulated on a photoreceptor surface and the cleaning member is pressed further thereon; accordingly, the filming tends to occur. However, according to the image forming apparatus of the exemplary embodiment, the external additive is inhibited from accumulation; accordingly, the filming is sufficiently suppressed to be able to achieve high image quality, high durability and high reliability.

Next, the image holding member used in the exemplary embodiment is described.

A known photoreceptor (photoreceptor for electrophotography) having at least a photosensitive layer formed on an electroconductive support can be used as the image holding member used in the invention, and preferable examples thereof include an organic photoreceptor. In the case where an organic image holding member is used in the embodiment, it is preferable that a layer constituting the outermost surface of the image holding member contains a resin having a crosslinked structure. Examples of the resin having a crosslinked structure includes a phenol resin, an urethane resin and a siloxane resin, and among them, a siloxane resin and a phenol resin are most preferable.

The image holding member wherein the resin having a crosslinked structure is contained in a layer constituting the outermost surface thereof has high strength and can thus have high resistance to abrasion and scratch so as to attain ultralong-durability of the image holding member. However, when a cleaning blade is used as a means of cleaning the image holding member to secure cleaning properties, the cleaning blade is preferably contacted at a relatively high abutting pressure with the image holding member. In this case, the toner remaining on the surface of the image holding member can be easily broken in the abutted region between the cleaning blade and the image holding member, so the constituent materials of the toner tend to adhere to the surface of the image holding member and subsequent change in charging easily occurs. However, the toner of the invention has excellent strength and can thus prevent such problem, and does not cause deterioration in image qualities for a long time even if it is used in combination with the system of re-utilizing the toner by recycling recovered residual toner as a developer.

The layer structure of the image holding member used in the embodiment is not particularly limited insofar as it comprises an electrically conductive support and a photosensitive layer arranged on the electrically conductive support, and the image holding member preferably has photosensitive layer consisting of at least a charge generating layer and a charge transporting layer different in functions each other, and preferably the layer structure specifically comprises an undercoat layer, a charge generating layer, a charge transporting layer and a protective layer in this order on the surface of an electrically conductive substrate. Hereinafter, the respective layers are described in detail.

Examples of the electrically conductive support include a metal plate, a metal drum and a metal belt using a metal such as aluminum, copper, zinc, stainless steel, chromium, nickel, molybdenum, vanadium, indium, gold and platinum or an alloy of any of these, or a paper, a plastic film and a belt coated, deposited or laminated with an electrically conductive polymer, an electrically conductive compound such as indium oxide, a metal such as aluminum, palladium and gold or an alloy of any of these. When the image holding member is used in a laser printer, the oscillation wavelength of the laser is preferably in a range of about 350 nm to about 850 nm, and shorter wavelength is more preferable for higher resolution of image.

For preventing interference fringes generated upon irradiation with laser beam, the surface of the support is preferably roughened to a central line average roughness (Ra) of about 0.04 μm to about 0.5 μm. The roughening method is preferably wet honing of the support with an aqueous suspension of an abrasive, center-less abrasion of continuously abrading the support against a rotating grindstone, anodizing, or formation of a layer containing organic or inorganic semiconductive particles.

Roughness outside of the above range is not suitable because when Ra is less than about 0.04 μm, the surface of the support assumes a mirror surface, thus failing to attain an interference preventing effect, while when Ra is greater than about 0.5 μm, image qualities are roughened even if a coating is formed. When a non-interference light is used as the light source, surface roughening for preventing interference fringes is not particularly necessary, generation of defects due to the uneven surface of the substrate can be prevented, and thus higher durability can be attained.

Anodizing includes anodizing, in an electrolyte solution, aluminum which is set as an anode so as to form an oxide film on the surface of aluminum. The electrolyte solution includes a sulfuric acid solution, oxalic acid solution and the like. However, the porous anodized film itself is chemically active, is easily polluted and significantly changes resistance depending on the environment. Accordingly, the anodized film is subjected to pore sealing wherein fine pores of the anodized film are closed by volume expansion with hydration reaction in pressurized water vapor or boiling water (to which a metallic salt of nickel or the like may be added) thereby converting it into a more stable hydrated oxide. The thickness of the anodized film is preferably in a range of about 0.3 μm to about 15 μm. When the thickness is less than about 0.3 μm, the film is poor in barrier properties against injection and unsatisfactory in effect. When the thickness is greater than about 15 μm, residual potential is increased due to repeated use.

The treatment with an acidic treating solution consisting of phosphoric acid, chromic acid and fluoric acid is carried out in the following manner. The compounding ratio of phosphoric acid, chromic acid and fluoric acid in the acidic treating solution is preferably established such that phosphoric acid is in a range of about 10% by weight to about 11% by weight, chromic acid in a range of about 3% by weight to about 5% by weight, and fluoric acid in a range of about 0.5% by weight to about 2% by weight, and the total concentration of these acids is in a range of about 13.5% by weight to about 18% by weight. The treatment temperature is preferably about 42° C. to about 48° C., and by keeping the treatment temperature high, a thick film can be formed more rapidly. The thickness of the film is preferably about 0.3 μm to about 15 μm. When the thickness of the film is less than about 0.3 μm, the film is poor in barrier properties against injection, and a satisfactory effect can not be attained. When the thickness of the film is greater than about 15 μm, residual electric potential is caused by repeated use.

Boehmite treatment can be carried out by dipping in pure water at about 90° C. to about 100° C. for about 5 minutes to about 60 minutes or by contacting with heated water vapor at about 90° C. to 120° C. for about 5 to about 60 minutes. The thickness of the film is preferably about 0.1 μm to about 5 μm. The film can further be subjected to anodizing with an electrolyte solution such as a solution containing adipic acid, boric acid, borate, phosphate, phthalate, maleate, benzoate, tartrate or citrate, in which the film is hardly dissolved. Examples of the organic or inorganic semi-electrically conductive particles include organic pigments such as perylene pigments described in JP-A No. 47-30330, bisbenzimidazole perylene pigments, polycyclic quinone pigments, indigo pigments or quinacridone pigments, organic pigments such as bisazo pigment or phthalocyanine pigment having an electron attractive substituent group such as a cyano group, a nitro group, a nitroso group or a halogen atom, and inorganic pigments such as zinc oxide, titanium oxide or aluminum oxide. Among these pigments, zinc oxide and titanium oxide are preferable because they have a high ability to transfer charge and are effective in film thickening.

For the purpose of improving dispersibility or regulating the energy level, the surfaces of these pigments are preferably treated with organic titanium compounds such as titanate coupling agent, aluminum chelate compound and aluminum coupling agent and particularly preferably treated with silane coupling agents such as vinyl trichlorosilane, vinyl trimethoxy silane, vinyl triethoxy silane, vinyl tris-2-methoxy ethoxy silane, vinyl triacetoxy silane, γ-glycidoxy propyl trimethoxy silane, γ-methacryloxy propyl trimethoxy silane, γ-aminopropyl triethoxy silane, γ-chloropropyl trimethoxy silane, γ-2-aminoethyl aminopropyl trimethoxy silane, γ-mercaptopropyl trimethoxy silane, γ-ureidopropyl triethoxy silane and β-3,4-epoxy cyclohexyl trimethoxy silane.

When the amount of the organic or inorganic semiconductive particles is too large, the strength of the undercoat layer is reduced to cause defects in a coating, and thus the semiconductive particles are used in an amount of preferably about 95% by weight or less, more preferably about 90% by weight or less. A method using a ball mill, a roll mill, a sand mill, an attriter or supersonic waves is used as the method of mixing and dispersing the organic or inorganic semiconductive particles. Mixing/dispersion is carried out in an organic solvent which may be any organic solvent dissolving an organometallic compound or resin and not causing gelation or aggregation upon mixing/dispersion of the organic or inorganic semi-electrically conductive particles. For example, an usual organic solvent such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene or toluene may be used singly or a mixed solvent of two or more of them may be used.

If necessary, an undercoat layer may be further formed between the electrically conductive support and the photosensitive layer.

Examples of the material used in forming the undercoat layer include organozirconium compounds such as zirconium chelate compound, zirconium alkoxide compound and zirconium coupling agent, organotitanium compounds such as titanium chelate compound, titanium alkoxide compound and titanate coupling agent, organoaluminum compounds such as aluminum chelate compound and aluminum coupling agent, and organometallic compounds such as antimony alkoxide compound, germanium alkoxide compound, indium alkoxide compound, indium chelate compound, manganese alkoxide compound, manganese chelate compound, tin alkoxide compound, tin chelate compound, aluminum silicon alkoxide compound, aluminum titanium alkoxide compound and aluminum zirconium alkoxide compound, and among them, organozirconium compounds, organotitanium compounds and organoaluminum compounds are preferably used because they exhibit excellent electrophotographic properties with low residual potential.

Further, silane coupling agents such vinyl trichlorosilane, vinyl trimethoxy silane, vinyl triethoxy silane, vinyl tris-2-methoxy ethoxy silane, vinyl triacetoxy silane, γ-glycidoxy propyl trimethoxy silane, γ-methacryloxy propyl trimethoxy silane, γ-aminopropyl triethoxy silane, γ-chloropropyl trimethoxy silane, γ-2-aminoethyl aminopropyl trimethoxy silane, γ-mercaptopropyl trimethoxy silane, γ-ureidopropyl triethoxy silane and β-3,4-epoxy cyclohexyl trimethoxy silane can be used in the undercoat layer.

It is also possible to use known binder resins conventionally used in the undercoat layer, for example polyvinyl alcohol, polyvinyl methyl ether, poly-N-vinylimidazole, polyethylene oxide, ethyl cellulose, methyl cellulose, ethylene-acrylic acid copolymer, polyamide, polyimide, casein, gelatin, polyethylene, polyester, phenol resin, vinyl chloride-vinyl acetate copolymer, epoxy resin, polyvinyl pyrrolidone, polyvinyl pyridine, polyurethane, polyglutamic acid and polyacrylic acid. The mixing ratio of these materials can be suitably selected depending on necessity.

An electron transporting pigment can be mixed and/or dispersed in the undercoat layer. Examples of the electron transporting pigments include organic pigments such as perylene pigment described in JP-A No. 47-30330, bisbenzimidazole perylene pigment, polycyclic quinone pigment, indigo pigment and quinacridone pigment, organic pigments such as bisazo pigment and phthalocyanine pigment having an electron attractive substituent group such as cyano group, nitro group, nitroso group or halogen atom, and inorganic pigments such as zinc oxide and titanium oxide.

Among these pigments, perylene pigment, bisbenzimidazole perylene pigment, polycyclic quinone pigment, zinc oxide and titanium oxide are preferably used because of their high electron mobility. These pigments may be surface-treated with the above-mentioned coupling agent, binder etc. for the purpose of regulating dispersibility and charge transportability. When the amount of the electron transport pigment is too high, the strength of the undercoat layer is reduced, and coating defects are generated, and thus the electron transporting pigment is used in an amount of about 95% by weight or less, preferably about 90% by weight or less.

As the mixing and/or dispersing method, a usual method of using a ball mill, a roll mill, a sand mill, an attriter or supersonic waves is used. Mixing/dispersion is carried out in an organic solvent which may be any organic solvent dissolving an organic metallic compound and resin and not causing gelation or aggregation upon mixing and/or dispersing of the electron transporting pigment. For example, an usual organic solvent such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene may be used singly, or a mixed solvent of two or more of them may be used.

The thickness of the undercoat layer is generally in a range of about 0.1 μm to about 30 μm, preferably in a range of about 0.2 μm to about 25 μm.

Examples of the coating method usable in forming the undercoat layer include usual methods such as blade coating, Meyer bar coating, spray coating, dipping coating, bead coating, air knife coating and curtain coating. The coating solution is dried to give the undercoat layer, and usually, drying is carried out at a temperature where a coating can be formed by evaporating the solvent. Particularly, a substrate treated with an acidic solution or boehmite becomes poor in ability to hide defects on the substrate, and thus an intermediate layer is preferably formed.

Further, the charge generating layer is described.

As a charge generation material used in forming the charge generating layer, use can be made of all known charge generation materials, for example azo pigments such as bisazo and trisazo, condensed aromatic pigments such as dibromoanthanthrone, organic pigments such as perylene pigment, pyrrolopyrrole pigment and phthalocyanine pigment, and inorganic pigments such as triclinic selenium and zinc oxide, and particularly when an exposure wavelength of about 380 nm to about 500 nm is used, an inorganic pigment is preferable, and when an exposure light wavelength of about 700 nm to about 800 nm is used, metallic and nonmetallic phthalocyanine pigments are preferable. Particularly, hydroxy gallium phthalocyanine disclosed in JP-A No. 5-263007 and JP-A No. 5-279591, chlorogallium phthalocyanine in JP-A No. 5-98181, dichlorotin phthalocyanine in JP-A No. 5-140472 and JP-A No. 5-140473, and titanyl phthalocyanine in JP-A No. 4-189873 and JP-A No. 5-43813 are preferable.

The binder resin used for forming the charge generating layer can be selected from a wide variety of insulating resins or can be selected from organic photo-conductive polymers such as poly-N-vinyl carbazole, polyvinyl anthracene, polyvinyl pyrene or polysilane. The binder resin is preferably insulating resin which includes, but is not limited to, polyvinyl butyral resin, polyarylate resin (such as a polycondensate of bisphenol A and phthalic acid), polycarbonate resin, polyester resin, phenoxy resin, vinyl chloride-vinyl acetate copolymer, polyamide resin, acryl resin, polyacrylamide resin, polyvinyl pyridine resin, cellulose resin, urethane resin, epoxy resin, casein, polyvinyl alcohol resin and polyvinyl pyrrolidone resin. These binder resins may be used singly or as a mixture of two or more of them.

The compounding ratio (weight ratio) of the charge generation material to the binder resin is preferably in a range of about 10:1 to about 1:10. As the method of dispersing them, use can be made of an usual method such as a ball mill dispersion method, an attriter dispersion method or a sand mill dispersion method, wherein conditions under which the crystalline form is not changed by dispersion are required. It is confirmed that the crystalline form is not changed after dispersion by the dispersion method carried out in the invention. In dispersion, it is preferred for the size of the particle to be reduced to a size of about 0.5 μm or less, more preferably about 0.3 μm or less, and even more preferably about 0.15 μm or less.

As the solvent used in the dispersion, ordinary organic solvent such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene or toluene may be used singly, or a mixed solvent of two or more of them may be used.

The thickness of the charge generating layer is generally in a range of about 0.1 to about 5 μm, preferably in a range of about 0.2 to about 2.0 μm. Examples of the coating method usable in forming the charge generating layer include usual methods such as blade coating, Meyer bar coating, spray coating, dipping coating, bead coating, air knife coating and curtain coating.

Further, the charge transporting layer is described in detail.

As the charge transporting layer, a layer formed by known techniques can be used. The charge transporting layer may be formed by using a charge transport material and binder resin or by using a polymeric charge transport material.

Examples of the charge transport material include electron transporting compounds such as quinone compounds such as p-benzoquinone, chloranil, bromanil or anthraquinone, tetracyanoquinodimethane compound, fluorenone compound such as 2,4,7-trinitrofluorenone, xanthone compound, benzophenone compound, cyanovinyl compound or ethylene compound, and hole transporting compounds such as triaryl amine compound, benzidine compound, aryl alkane compound, aryl-substituted ethylene compound, stilbene compound, anthracene compound or hydrazone compound. These charge transport materials can be used singly or as a mixture of two or more thereof, and the charge transport material is not limited thereto. While these charge transport materials can be used singly or as a mixture of two or more of them, from the viewpoint of mobility, the charge transport materials are preferably those having structures represented by any one of the following Formulae (A) to (C).

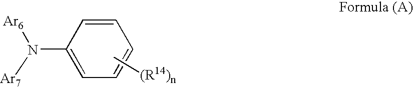

In Formula (A), R¹⁴ represents a hydrogen atom or a methyl group; n is 1 or 2; Ar₆ and Ar₇ each represent a substituted or unsubstituted aryl group, and a substituent group of the aryl group is selected from the group consisting of a halogen atom, an alkyl group having 1 to 5 carbon atoms, an alkoxy group having 1 to 5 carbon atoms, or an amino group substituted by an alkyl group having 1 to 3 carbon atoms.

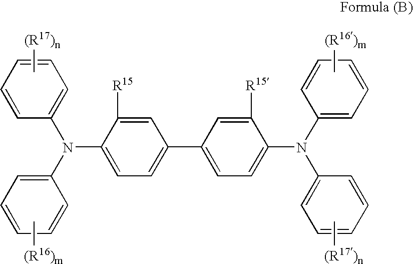

In Formula (B), R¹⁵ and R¹⁵′ may be the same or different and each represent a hydrogen atom, a halogen atom, an alkyl group having 1 to 5 carbon atoms, or an alkoxy group having 1 to 5 carbon atoms; R¹⁶, R^{16′}, R¹⁷ and R^{17′} may be the same or different and each represent a hydrogen atom, a halogen atom, an alkyl group having 1 to 5 carbon atoms, an alkoxy group having 1 to 5 carbon atoms, an amino group substituted by an alkyl group having 1 or 2 carbon atoms, a substituted or unsubstituted aryl group, —C(R¹⁸)═C(R¹⁹)(R²⁰), or —CH═CH—CH═C(Ar)₂; R¹⁸, R¹⁹ and R²⁰ each represent a hydrogen atom, a substituted or unsubstituted alkyl group, or a substituted or unsubstituted aryl group; Ar represents a substituted or unsubstituted aryl group; and each of m and n is an integer of 0 to 2.

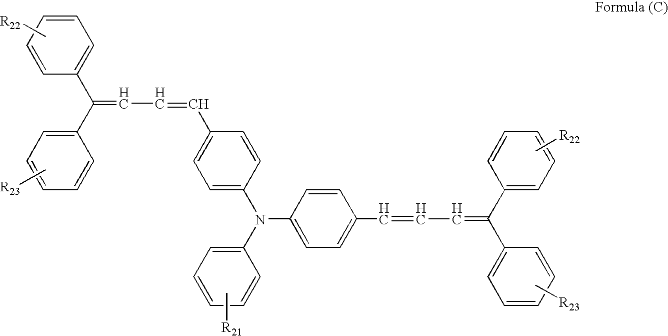

In Formula (C), R₂₁ represents a hydrogen atom, an alkyl group having 1 to 5 carbon atoms, an alkoxy group having 1 to 5 carbon atoms, a substituted or unsubstituted aryl group, or —CH═CH—CH═C(Ar)₂; Ar represents a substituted or unsubstituted aryl group; R₂₂ and R₂₃ may be the same or different and each represent a hydrogen atom, a halogen atom, an alkyl group having 1 to 5 carbon atoms, an alkoxy group having 1 to 5 carbon atoms, an amino group substituted by an alkyl group having 1 or 2 carbon atoms, or a substituted or unsubstituted aryl group.

As the binder resin used in the charge transporting layer, it is possible to use polymer charge transport materials such as polycarbonate resin, polyester resin, methacryl resin, acryl resin, polyvinyl chloride resin, polyvinylidene chloride resin, polystyrene resin, polyvinyl acetate resin, styrene-butadiene copolymer, vinylidene chloride-acrylonitrile copolymer, vinyl chloride-vinyl acetate copolymer, vinyl chloride-vinyl acetate-maleic anhydride copolymer, silicone resin, silicone-alkyd resin, phenol-formaldehyde resin, styrene-alkyd resin, poly-N-vinyl carbazole, polysilane, as well as polyester polymeric charge transport materials and polymeric charge transport materials described in JP-A No. 8-176293 or JP-A No. 8-208820. These binder resins can be used singly or as a mixture of two or more thereof. The compounding ratio (weight ratio) of the charge transport material to the binder resin is preferably from about 10:1 to about 1:5.

For formation of the charge transporting layer, the polymer charge transport materials can be singly used. As the polymer charge transport materials, known materials having charge transportability, such as poly-N-vinyl carbazole and polysilane, can be used. Particularly polyester polymeric charge transport materials described in JP-A No. 8-176293 and JP-A No. 8-208820 have high charge transportability and are particularly preferable. While the polymeric charge transport material can be singly used as the charge transporting layer, it may be mixed with the binder resin to form a coated film.

The thickness of the charge transporting layer is generally in a range of about 5 μm to about 50 μm, preferably in a range of about 10 μm to about 30 μm.

As the coating method, it is possible to use an usual method such as blade coating, Meyer bar coating, spray coating, dipping coating, bead coating, air knife coating and curtain coating. The solvent used in forming the charge transporting layer includes usual organic solvents such as aromatic hydrocarbons such as benzene, toluene, xylene and chlorobenzene, ketones such as acetone and 2-butanone, halogenated aliphatic hydrocarbons such as methylene chloride, chloroform and ethylene chloride, and cyclic or linear ethers such as tetrahydrofuran and ethyl ether. These solvents may be used singly or a in a mixture of two or more of them.

For the purpose of preventing the deterioration of the image holding member due to ozone or an oxidized gas generated in a copier or due to light or heat, additives such as an antioxidant, a light stabilizer or a heat stabilizer can be added to the photosensitive layer. For example, the antioxidant includes hindered phenol, hindered amine, paraphenylene diamine, aryl alkane, hydroquinone, spirochroman, spiroindanone and derivatives thereof, organic sulfur compounds, organic phosphorous compounds, etc. Examples of the light stabilizer include derivatives of benzophenone, benzotriazole, dithiocarbamate, tetramethyl piperidine and the like.

For the purpose of improvement in sensitivity, reduction in residual potential, reduction in fatigue upon repeated use, etc., at least one of electron receptor can be contained. Examples of the electron receptor usable in the image holding member of the invention include succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, phthalic acid and compounds represented by Formula (I). Among these compounds, fluorenone electron receptors, quinone electron receptors and benzene derivatives having electron-attracting substituent such as Cl, CN or NO₂ are particularly preferable.

Further, the protective layer (layer which constitutes the outermost surface) is described in detail.

To confer resistance to abrasion, scratch etc. on the protective layer, a high-strength protective layer can also be formed. This high-strength protective layer is preferably a layer wherein electrically conductive particles are dispersed in a binder resin, or lubricating particles such as fluorine resin, acryl resin etc. are dispersed in an usual charge transport material, or a hard coating agent such as silicone and acryl, and from the viewpoint of strength, electric characteristics and image quality maintenance, the protective layer preferably contains resin having a crosslinked structure, and more preferably further contains a charge transport material. As the resin having a crosslinked structure, various materials can be used, and in respect of characteristics, phenol resin, urethane resin, siloxane resin etc. are preferable, and particularly a protective layer having at least a siloxane resin or a phenol resin is preferable.

Specifically, a protective layer having a structure derived from a compound represented by Formula (I) or (II) is excellent in strength and stability and is thus particularly preferable.

F-[D-Si(R²)₍₃₋ₐ₎Qₐ]_{b} (I)

In Formula (I), F is an organic group derived from a compound having hole transportability, D is a flexible subunit, R² represents hydrogen, an alkyl group or a substituted or unsubstituted aryl group, Q represents a hydrolyzable group, a is an integer of 1 to 3, and b is an integer of 1 to 4.

The flexible subunit represented by D in Formula (I) contain essentially —(CH₂)ₙ— group, which may be combined with —COO—, —O—, —CH═CH— or —CH═N— group to form a divalent linear group. In the —(CH₂)ₙ— group, n is an integer of 1 to 5. The hydrolyzable group represented by Q represents —OR group wherein R represents an alkyl group.

F—((X)ₙR₁-ZH)ₘ (II)

In Formula (II), F is an organic group derived from a compound having hole transportability, R₁ is an alkylene group, Z is —O—, —S—, —NH— or —COO—, and m is an integer of 1 to 4. X represents —O— or —S—, and n is 0 or 1.

The compound represented by Formula (I) or (II) is more preferably a compound wherein the organic group F is represented particularly by the following Formula (III):

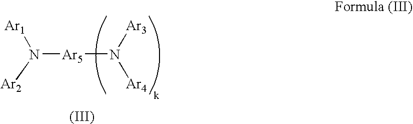

In Formula (III), Ar₁ to Ar₄ independently represent a substituted or unsubstituted aryl group; Ar₅ represents a substituted or unsubstituted aryl or arylene group and simultaneously two to four of Ar₁ to Ar₅ have a linking bond represented by -D-Si(R²)₍₃₋ₐ₎Qₐ in Formula (I); k represents 0 or 1; D represents a flexible subunit; R² represents hydrogen, an alkyl group or a substituted or unsubstituted aryl group; Q represents a hydrolyzable group; and a is an integer of 1 to 3; and k is 0 or 1.

In Formula (III), Ar₁ to Ar₄ independently represent a substituted or unsubstituted aryl group, and are specifically preferably groups represented by the following structure group 1.

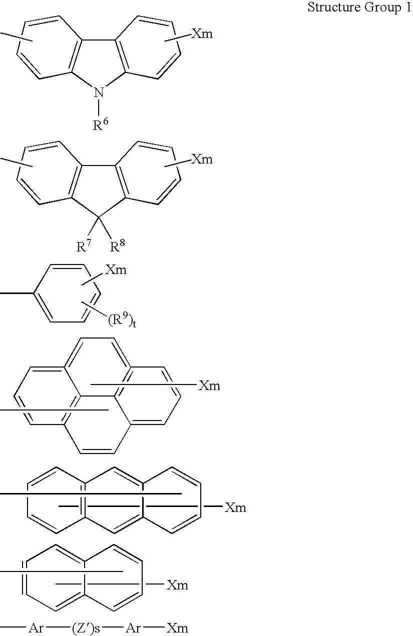

Ar shown in the structure group 1 is preferably selected from the following structure group 2, and Z′ is selected preferably from the following structure group 3.

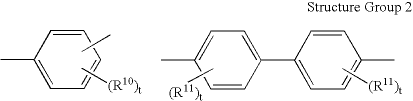

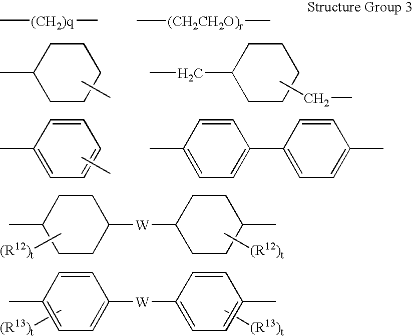

In the structure groups 1 to 3, R⁶ represents a hydrogen atom or a group which is selected from the group consisting of an alkyl group having 1 to 4 carbon atoms, a phenyl group substituted by an alkyl group having 1 to 4 carbon atoms, a phenyl group substituted by an alkoxy group having 1 to 4 carbon atoms, an unsubstituted phenyl group, and an aralkyl group having 7 to 10 carbon atoms.

Each of R⁷ to R¹³ is selected from hydrogen, an alkyl group having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms, or halogen.

m and s each represent 0 or 1; q and r each represent an integer of 1 to 10; and t represents an integer of 1 to 3. X represents a group represented by -D-Si(R²)₍₃₋ₐ₎Qₐ in Formula (I).

W shown in the structure group 3 is preferably represented by the following structure group 4. In the structure group 4, s′ represents an integer of 0 to 3.

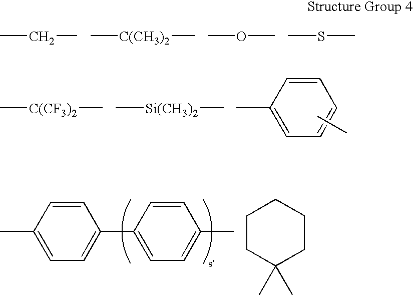

One embodiment of specific structures of Ar₅ in Formula (III) include a structure in which m in the structure of Ar₁ to Ar₄ is 1 when k=0, and a structure in which m in the structure of Ar₁ to Ar₄ is 0 when k=1.

To control various physical properties such as strength or film resistance, a compound represented by the following Formula (IV) may be further added to the protective layer.

Si(R²)_{(4-c)}Q_{c} (IV)

In Formula (IV), R² represents a hydrogen atom, an alkyl group or a substituted or unsubstituted aryl group; Q represents a hydrolyzable group; and c is an integer of 1 to 4.

Specific examples of the compounds represented by Formula (VI) include the following silane coupling agents: Tetrafunctional alkoxy silane (c=4) such as tetramethoxy silane and tetraethoxy silane; trifunctional alkoxy silane (c=3) such as methyl trimethoxy silane, methyl triethoxy silane, ethyl trimethoxy silane, methyl trimethoxy ethoxy silane, vinyl trimethoxy silane, vinyl triethoxy silane, phenyl trimethoxy silane, γ-glycidoxy propyl methyl diethoxy silane, γ-glycidoxy propyl trimethoxy silane, γ-glycidoxy propyl trimethoxy silane, γ-aminopropyl triethoxy silane, γ-aminopropyl trimethoxy silane, γ-aminopropyl methyl dimethoxy silane, N-β(aminoethyl)γ-aminopropyl triethoxy silane, (tridecafluoro-1,1,2,2-tetrahydrooctyl)triethoxy silane, (3,3,3-trifluoropropyl)trimethoxy silane, 3-(heptafluoroisopropoxy)propyl triethoxy silane, 1H,1H,2H,2H-perfluoroalkyl triethoxy silane, 1H,1H,2H,2H-perfluorodecyl triethoxy silane and 1H,1H,2H,2H-perfluorooctyl triethoxy silane; bifunctional alkoxy silane (c=2) such as dimethyl dimethoxy silane, diphenyl dimethoxy silane and methyl phenyl dimethoxy silane; and monofunctional alkoxy silane (c=1) such as trimethyl methoxy silane. For improving film strength, tri- and tetrafunctional alkoxy silane is preferable, and for improving flexibility and film formability, di-functional alkoxy silane and monofunctional alkoxy silane are preferable.

Silicone hard coating agents prepared mainly from these coupling agents can also be used. Examples of commercially-available hard coating agent include KP-85, X-40-9740, X-40-2239 (all trade names, manufactured by Shin-Etsu Chemical Co., Ltd.) and AY42-440, AY42-441 and AY49-208 ((all trade names, manufactured by Dow Corning Toray Co., Ltd.).

To increase strength, it is also preferable to use a compound having two or more silicon atoms represented by the following Formula.

B—(Si(R²)₍₃₋ₐ₎Qₐ)₂ (V)

In Formula (V), B represents a divalent organic group, R² represents hydrogen, an alkyl group or a substituted or unsubstituted aryl group, Q represents a hydrolyzable group, and a is an integer of 1 to 3.

Specifically, preferable examples include materials shown in Table 1 below, while the invention is not limited thereto.

TABLE 1

| No. | Structural Formula |
|---|---|
| V-1 | (MeO)₃Si—(CH₂)₂—Si(OMe)₃ |
| V-2 | (MeO)₂MeSi—(CH₂)₂—SiMe(OMe)₂ |
| V-3 | (MeO)₂MeSi—(CH₂)₆—SiMe(OMe)₂ |
| V-4 | (MeO)₃Si—(CH₂)₆—Si(OMe)₃ |
| V-5 | (EtO)₃Si—(CH₂)_{6—Si(OEt)}₃ |
| V-6 | (MeO)₂MeSi—(CH₂)₁₀—SiMe(OMe)₂ |
| V-7 | (MeO)₃Si—(CH₂)₃—NH—(CH₂)₃—Si(OMe)₃ |
| V-8 | (MeO)₃Si—(CH₂)₃—NH—(CH₂)₂—NH—(CH₂)₃—Si(OMe)₃ |
| V-9 | 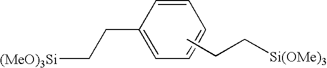 |
| V-10 | 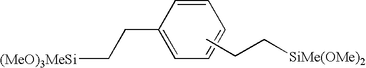 |
| V-11 | 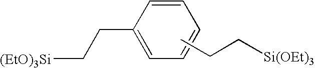 |
| V-12 | 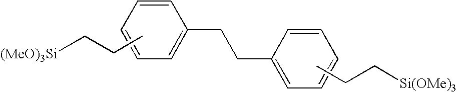 |
| V-13 | 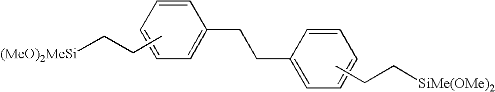 |
| V-14 | 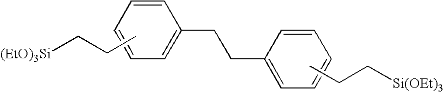 |
| V-15 | (MeO)₃SiC₃H₆—O—CH₂CH{—O—C₃H₆Si(OMe)₃}—CH₂{—O—C₃H₆Si(OMe)₃} |
| V-16 | (MeO)₃SiC₂H₄—SiMe₂—O—SiMe₂—O—SiMe₂—C₂H₄Si(OMe)₃ |

For control of film characteristics, prolongation of liquid durability, etc., a resin soluble in an alcohol solvent or a ketone solvent can be added. Such resin includes polyvinyl butyral resin, polyvinyl formal resin, polyvinyl acetal resin such as partially acetalated polyvinyl acetal resin having a part of butyral modified with formal, acetoacetal or the like (for example, S-LEC B and S-LEC K (both trade names, manufactured by Sekisui Chemical Co., Ltd.)), polyamide resin, cellulose resin, phenol resin etc. Particularly, polyvinyl acetal resin is preferable from the viewpoint of electric characteristics.

For the purpose of discharging gas resistance, mechanical strength, scratch resistance, particle dispersibility, viscosity control, torque reduction, abrasion control and prolongation of pot life, etc., various resins can be added. A resin soluble in alcohol is preferably added particularly to the siloxane resin.

Examples of the resin soluble in an alcohol solvent include polyvinyl butyral resin, polyvinyl formal resin, polyvinyl acetal resin such as partially acetalated polyvinyl acetal resin having a part of butyral modified with formal, acetoacetal or the like (for example, S-LEC B and S-LEC K (both trade names, manufactured by Sekisui Chemical Co., Ltd.)), polyamide resin, cellulose resin, phenol resin and the like. Particularly, polyvinyl acetal resin is preferable from the viewpoint of electric characteristics.

The molecular weight of the resin is preferably in a range of about 2,000 to about 100,000, and more preferably in a range of about 5,000 to about 50,000. When the molecular weight is less than about 2,000, the desired effect cannot be achieved, while when the molecular weigh is greater than about 100,000, the solubility is decreased, the amount of the resin added is limited, and coating defects are caused upon coating. The amount of the resin added is preferably about 1% by weight to about 40% by weight, more preferably about 1% by weight to about 30% by weight, most preferably about 5% by weight to about 20% by weight. When the amount is less than about 1% by weight, it is difficult to obtain the desired effect, while when the amount is greater than about 40% by weight, image blurring may easily occur under high temperature and high humidity. These resins may be used singly or as a mixture thereof.

For prolongation of pot life, control of film characteristics, etc., a cyclic compound having a repeating structural unit represented by the following Formula (VI), and a derivative thereof, can also be included.

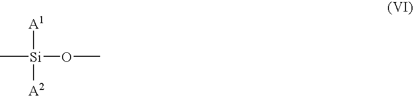

In Formula (VI), A¹ and A² independently represent a monovalent organic group.

The cyclic compound having a repeating structural unit represented by Formula (VI) can include commercial cyclic siloxane. Specific examples thereof include cyclic siloxane, for example cyclic dimethyl cyclosiloxane such as hexamethyl cyclotrisiloxane, octamethyl cyclotetrasiloxane, decamethyl cyclopentasiloane and dodecamethyl cyclohexasiloxane, cyclic methyl phenyl cyclosiloxane such as 1,3,5-trimethyl-1,3,5-triphenyl cyclotrisiloxane, 1,3,5,7-tetramethyl-1,3,5,7-tetraphenyl cyclotetrasiloxane, and 1,3,5,7,9-pentamethyl-1,3,5,7,9-pentaphenyl cyclopentasiloxane, cyclic phenyl cyclosiloxane such as hexaphenyl cyclotrisiloxane, fluorine-containing cyclosiloxane such as 3-(3,3,3-trifluoropropyl) methyl cyclotrisiloxane, a methyl hydroxy siloxane mixture, hydrosilyl group-containing cyclosiloxane such as pentamethyl cyclopentasiloxane and phenyl hydrocyclosiloxane, and vinyl group-containing cyclosiloxane such as pentavinyl pentamethyl cyclopentasiloxane. These cyclic siloxane compounds can be used singly or as a mixture thereof.

To improve the stain resistance and lubricating properties of the surface of the image holding member, various fine particles can also be added. Such fine particles can be used singly or two or more of them can be used in combination. Examples of the fine particles include silicon-containing particles. The silicon-containing fine particles are particles containing silicon as a constituent element, and specific examples thereof include colloidal silica and silicone fine particles. The colloidal silica used as the silicon-containing fine particles is preferably selected from those which have an average particle diameter of about 1 nm to about 100 nm, preferably about 10 nm to about 30 nm, and are dispersed in acidic or alkaline aqueous liquids or an organic solvent such as alcohol, ketone or ester, and generally commercially available products can be used therefor. While the solids content of colloidal silica in the outermost surface is not limited, it is preferably in a range of about 0.1% by weight to about 50% by weight, and more preferably about 0.1% by weight to about 30% by weight with respect to a mass of total solid content of outermost surface layer of the image holding member, from the viewpoints of film formability, electric characteristics and strength.

The silicone fine particles used as the silicon-containing fine particles are selected from spherical silicone resin particles, silicone rubber particles or silicone surface-treated silica particles having an average particle diameter of about 1 nm to about 500 nm, preferably about 10 nm to about 100 nm, and generally commercially available products can be used therefor. The silicone fine particles are chemically inert particles having a small diameter and are excellent in dispersibility in resin. Since the content of the silicone fine particles required for achieving sufficient characteristics is low, the surface state of the image holding member can be improved without inhibiting crosslinking reaction. That is, the silicone fine particles can be uniformly incorporated into the rigid crosslinked structure and can simultaneously improve lubricating properties and water repellence of the surface of the image holding member so as to maintain excellent abrasion resistance and stain resistance for a long time.

The content of the silicone fine particles in the outermost layer of the image holding member is preferably in a range of about 0.1% by weight to about 30% by weight, preferably in a range of about 0.5% by weight to about 10% by weight, based on the total solids content of the outermost surface layer.

Other particles can include fluorine-containing particles such as ethylene tetrafluoride, ethylene trifluoride, propylene hexafluoride, vinyl fluoride, vinylidene fluoride etc., particles consisting of a resin produced by copolymerizing the fluorine resin with a monomer having a hydroxyl group, for example particles shown in “Preliminary Collection of Eighth Polymer Material Forum Lectures, p. 89” (in Japanese), and semi-conductive metal oxides such as ZnO—Al₂O₃, SnO₂—Sb₂O₃, In₂O₃—SnO₂, ZnO—TiO₂, ZnO—TiO₂, MgO—Al₂O₃, FeO—TiO₂, TiO₂, SnO₂, In₂O₃, ZnO and MgO.

For the same purpose of improving lubricating properties and water repellence of the surface of the image holding member, oil such as silicone oil can also be added. Examples of the silicone oil include silicone oils such as dimethyl polysiloxane, diphenyl polysiloxane or phenyl methyl siloxane, and reactive silicone oils such as amino-modified polysiloxane, epoxy-modified polysiloxane, carboxyl-modified polysiloxane, carbinol-modified polysiloxane, methacryl-modified polysiloxane, mercapto-modified polysiloxane or phenol-modified polysiloxane.

The ratio of exposure of the particles to the surface of the protective layer is preferably 40% or less. When the degree of exposure is higher than the range, the influence of the particles themselves is increased, and image deletion due to low resistance easily occurs. In the preferable range, the degree of exposure is more preferably about 30% or less since the particles exposed to the surface are effectively refreshed with a cleaning member, and depression of filming of toner component on the surface of the image holding member, removal of discharge products, and reduction in abrasion of a cleaning member due to torque reduction are maintained for a long period of time.

Additives such as a plasticizer, a surface modifier, an antioxidant or a photo-deterioration inhibitor can also be used. Examples of the plasticizer include biphenyl, biphenyl chloride, terphenyl, dibutyl phthalate, diethylene glycol phthalate, dioctyl phthalate, triphenyl phosphoric acid, methylnaphthalene, benzophenone, chlorinated paraffin, polypropylene, polystyrene and various fluorohydrocarbons.

An antioxidant having a hindered phenol, hindered amine, thioether or phosphite partial structure can be added to the protective layer, and is effective in improving potential stability and image qualities when the environment is changed. Examples of the antioxidant includes: hindered phenol antioxidants such as: “SUMILIZER BHT-R”, “SUMILIZER MDP-S”, “SUMILIZER BBM-S”, “SUMILIZER WX-R”, “SUMILIZER NW”, “SUMILIZER BP-76”, “SUMILIZER BP-101”, “SUMILIZER GA-80”, “SUMILIZER GM” or “SUMILIZER GS”, which are all trade names and manufactured by Sumitomo Chemical Co., Ltd.; “IRGANOX1010”, “IRGANOX1035”, “IRGANOX1076”, “IRGANOX1098”, “IRGANOX1135”, “IRGANOX1141”, “IRGANOX1222”, “IRGANOX1330”, “IRGANOX1425WL”, “IRGANOX1520L”, “IRGANOX245”, “IRGANOX259”, “IRGANOX3114”, “IRGANOX3790”, “IRGANOX5057” or “IRGANOX565”, which are all trade names and manufactured by Ciba Specialty Chemicals; “ADEKASTAB AO-20”, “ADEKASTAB AO-30”, “ADEKASTAB AO-40”, “ADEKASTAB AO-50”, “ADEKASTAB AO-60”, “ADEKASTAB AO-70”, “ADEKASTAB AO-80” and “ADEKASTAB AO-330”, which are all trade names and manufactured by Asahi Denka Co., Ltd., hindered amine antioxidants such as: “SANOL LS2626”, “SANOL LS765”, “SANOL LS770”, “SANOL LS744”, “TINUBIN 144”, “TINUBIN 622LD”, “MARK LA57”, “MARK LA67”, “MARK LA62”, “MARK LA68”, “MARK LA63” or “SUMILIZER TPS”, thioether antioxidants such as “SUMILIZER TP-D”, and phosphite antioxidants such as: “MARK 2112”, “MARK PEP•8”, “MARK PEP•24G”, “MARK PEP•36”, “MARK 329K” or “MARK HP•10”, and particularly preferable examples among these include hindered phenol and hindered amine antioxidants. These may be modified by a substituent capable of crosslinking with a material forming a crosslinked film, and examples of the substituent include an alkoxysilyl group.

A catalyst is preferably added or used in a coating solution used in forming the protective layer or at the time of preparing the coating solution. Examples of the catalyst used include inorganic acids such as hydrochloric acid, acetic acid, phosphoric acid and sulfuric acid, organic acids such as formic acid, propionic acid, oxalic acid, p-toluenesulfonic acid, benzoic acid, phthalic acid and maleic acid, and alkali catalysts such as potassium hydroxide, sodium hydroxide, calcium hydroxide, ammonia and triethylamine, and the following insoluble solid catalysts may be used.

Examples of the insoluble solid catalysts include cation exchange resins such as AMBERLITE 15, AMBERLITE 200C and AMBERLYST 15E (manufactured by Rohm and Haas Company); DOW X MWC-1-H, DOW X 88 and DOW X HCR-W2 (manufactured by Dow Chemical Company); Levatit SPC-108 and Levatit SPC-118 (manufactured by Bayer AG); DIAION RCP-150H (manufactured by Mitsubishi Chemical Industries); SUMIKA ION KC-470, DUOLITE C26-C, DUOLITE C-433 and DUOLITE-464 (manufactured by Sumitomo Chemical Co., Ltd.); and NAPHION-H (manufactured by DuPont); anion exchange resins such as AMBERLITE IRA-400 and AMBERLITE IRA-45 (manufactured by Rohm and Haas Company); inorganic solids having groups containing protonic acid groups such as Zr(O₃PCH₂CH₂SO₃H)₂ and Th(O₃PCH₂CH₂COOH)₂ bound to the surface thereof; polyorganosiloxane containing protonic acid groups, such as polyorganosiloxane having sulfonic acid groups; heteropoly acids such as cobalt tungstic acid and phosphomolybdic acid; isopoly acids such as niobic acid, tantalic acid and molybdic acid; mono metal oxides such as silica gel, alumina, chromia, zirconia, CaO and MgO; composite metal oxides such as silica-alumina, silica-magnesia, silica-zirconia, and zeolite; clay minerals such as acidic clay, active clay, montmorilonite and kaolinite; metal sulfates such as LiSO₄ and MgSO₄; metal phosphates such as zirconia phosphate and lanthanum phosphate; metal nitrates such as LiNO₃ and Mn(NO₃)₂; inorganic solids having amino group-containing groups bound to the surface thereof, such as solids obtained by reacting aminopropyl triethoxy silane with silica gel; and polyorganosiloxane containing amino groups, such as amino-modified silicone resin.

It is preferable that a solid catalyst insoluble in a photo-functional compound, reaction products, water and solvent is used in preparing the coating solution, because the stability of the coating solution tends to be improved. The solid catalyst insoluble in the system is not particularly limited insofar as the catalyst component is a compound represented by Formula (I), (II), (III) or (V), or is insoluble in other additives, water, solvent etc. The amount of the solid catalyst used is not particularly limited and is preferably in a range of about 0.1 parts by weight to about 100 parts by weight with respect to 100 parts by weight of the total amount of compounds having a hydrolyzable group. As described above, the solid catalyst is insoluble in the starting compounds, reaction products and solvent, and can thus be easily removed in a usual manner after the reaction. While the reaction temperature and reaction time are selected suitably depending on the type and amount of the starting compounds and solid catalyst used, the reaction temperature is preferably in a range of about 0° C. to about 100° C., more preferably in a range of about 10° C. to about70° C., and even more preferably in a range of about 15 to 50° C., and the reaction temperature is preferably in a range of about 10 minutes to 100 hours. When the reaction time is longer than the upper limit mentioned above, gelation tends to easily occur.

When a catalyst insoluble in the system is used in preparing the coating solution, another catalyst which can be dissolved in the system is preferably simultaneously used for the purpose of improving strength, liquid storage stability, and the like. In addition to the above-mentioned catalysts, examples of such another catalyst further include organoaluminum compounds such as aluminum triethylate, aluminum triisopropylate, aluminum tri(sec-butyrate), mono(sec-butoxy) aluminum diisopropylate, diisopropoxy aluminum(ethyl acetoacetate), aluminum tris(ethyl acetoacetate), aluminum bis(ethyl acetoacetate) monoacetyl acetonate, aluminum tris(acetyl acetonate), aluminum diisopropoxy(acetyl acetonate), aluminum isopropoxy-bis(acetyl acetonate), aluminum tris(trifluoroacetyl acetonate), aluminum tris(hexafluoroacetyl acetonate), etc.

In addition to the organoaluminum compounds, it is also possible to use organotin compounds such as dibutyltin dilaurate, dibutyltin dioctiate and dibutyltin diacetate; organotitanium compounds such as titanium tetrakis(acetyl acetonate), titanium bis(butoxy)bis(acetyl acetonate) and titanium bis(isopropoxy)bis(acetyl acetonate); and zirconium compounds such as zirconium tetrakis(acetyl acetonate), zirconium bis(butoxy)bis(acetyl acetoate) and zirconium bis(isopropoxy)bis(acetyl acetonate), but from the viewpoints of safety, low cost, and pot-life length, the organoaluminum compounds are preferably used, and particularly the aluminum chelate compounds are more preferable. While the amount of these catalysts used is not particularly limited, it is preferably in a range of about 0.1 parts by weight to about 20 parts by weight, more preferably in a range of about 0.3 parts by weight to about 10 parts by weight, relative to 100 parts by weight of the total amount of compounds having a hydrolyzable group.

When the organometallic compound is used as a catalyst, a multidentate ligand is preferably added from the viewpoints of pot life and curing efficiency. While examples of the multidentate ligand include the following ligands and ligands derived therefrom, the invention is not limited thereto.

Specific examples of the multidentate ligand include β-diketones such as acetyl acetone, trifluoroacetyl acetone, hexafluoroacetyl acetone and dipivaloyl methyl acetone; acetoacetates such as methyl acetoacetate and ethyl acetoacetate; bipyridine and derivatives thereof; glycine and derivatives thereof; ethylene diamine and derivatives thereof; 8-oxyquinoline and derivatives thereof; salicylaldehyde and derivatives thereof; catechol and derivatives thereof; bidentate ligands such as 2-oxyazo compounds; diethyl triamine and derivatives thereof tridendate ligands such as nitrilotriacetic acid and derivatives thereof; and hexadentate ligands such as ethylenediaminetetraacetic acid (EDTA) and derivatives thereof. In addition to the organic ligands described above, inorganic ligands such as pyrophosphoric acid and triphosphoric acid can be mentioned. The multidentate ligand is particularly preferably a bidentate ligand, and specific examples thereof include bidentate ligands represented by the following Formula (VII) in addition to those described above. Among these ligands, the bidentate ligands represented by formula (VII) below are more preferable, and those of Formula (VII) wherein R⁵ and R⁶ are the same are particularly preferable. When R⁵ is the same as R⁶, the coordination strength of the ligand in the vicinity of room temperature can be increased to achieve further stabilization of the coating solution.

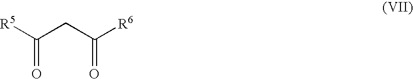

In Formula (VII), R⁵ and R⁶ independently represent an alkyl group having 1 to 10 carbon atoms, an alkyl fluoride group, or an alkoxy group having 1 to 10 carbon atoms.

While the amount of the multidentate ligand incorporated can be arbitrarily selected, it is preferable that the amount is about 0.01 mole or more, preferably about 0.1 mole or more, more preferably about 1 mole or more, with respect to 1 mole of the organometallic compound used.

While the production of the coating solution can also be conducted in the absence of a solvent, various solvents may be used in addition to alcohols such as methanol, ethanol, propanol and butanol; ketones such as acetone and methyl ethyl ketone; tetrahydrofuran; and ethers such as diethyl ether and dioxane in accordance with necessity. Such solvents preferably have a boiling point of about 100° C. or lower and can be arbitrarily mixed before use. While the amount of the solvent can be arbitrarily selected, in consideration to the fact that the organosilicon compound can be easily precipitated when the amount is too low, the amount of the solvent is preferably about 0.5 part by weight to about 30 parts by weight, more preferably about 1 part by weight to about 20 parts by weight, with respect to 1 part by weight of the organosilicon compound.

While the reaction temperature and reaction time for curing the coating solution are not particularly limited, from the viewpoints of the mechanical strength and chemical stability of the resulting silicone resin, the reaction temperature is preferably about 60° C. or higher, more preferably in a range of about 80° C. to about 200° C., and the reaction time is preferably about 10 minutes to about 5 hours. To allow a protective layer obtained by curing the coating solution to be kept in a highly humid state is effective in improving the properties of the protective layer. Depending on applications, the protective layer can be hydrophobilized by surface treatment with hexamethyl disilazane or trimethyl chlorosilane.

On the other hand, it is more preferable that the phenol resin is that containing at least one charge transporting material (structural unit having a charge transporting ability) selected from a hydroxyl group, a carboxyl group, an alkoxysilyl group, an epoxy group, a thiol group and an amino group.

Examples of the phenol derivative used in synthesizing the phenol resin include compounds having a phenol structure, such as resorcine, bisphenol, substituted phenols having one hydroxy group such as phenol, cresol, xylenol, paraalkylphenol, or paraphenylphenol, substituted phenols having two hydroxy groups such as catechol, resorcinol, or hydroquinone, bisphenols such as bisphenol A or bisphenol Z, and biphenols. Compounds which are generally commercially available as a raw material for synthesizing a phenol resin can be utilized in the embodiment.

Compounds having a methylol group can also be utilized as the phenol derivative, and examples thereof include monomers of monomethylolphenols, dimethylolphenols or trimethylolphenols, mixtures thereof, oligomers thereof, and mixtures of those monomers and oligomers.

In the specification, a relatively large molecule having around 2 to 20 of repeating molecular structural units is referred to as oligomer, and a smaller molecule is referred to as monomer.

Examples of the aldehydes used in synthesizing the phenol resin include formaldehyde and paraformaldehyde. Upon synthesis of the phenol resin, the resin can be obtained by reacting these raw materials under an acid catalyst or an alkali catalyst. Alternatively, aldehydes which are generally commercially available as a phenol resin can also be used.

Examples of the acid catalyst include sulfuric acid, paratoluenesulfonic acid, and phosphoric acid. Examples of the alkali catalyst include hydroxides of alkali metals and alkaline earth metals such as NaOH, KOH, Ca(OH)₂, and Ba(OH)₂, and amine catalysts.

Examples of the amine catalyst include ammonia, hexamethylenetetramine, trimethylamine, triethylamine, and triethanolanine, while the amine catalyst is not limited thereto.

When the basic catalyst is used in the invention, carriers can be remarkably trapped by the remaining catalyst, and electrophotographic property can be deteriorated in some cases. For this reason, when the basic catalyst is utilized, it is preferable that the catalyst is inactivated or removed by neutralizing with an acid, or by contacting with an adsorbing agent such as silica gel, or an ion exchange resin, after completion of the reaction utilizing the catalyst.

The phenol resin having a crosslinked structure used in the embodiment may be a resin obtained by further crosslinking conventionally-known phenol resin, or may be a resin in which a phenol resin itself has a crosslinked structure, such as a novolak resin. In the former case, it is more preferable to use a resol phenol resin.

Particularly, since the toner containing a crystalline resin like the toner of the embodiment has hygroscopicity, it is more preferably used in view of stably obtaining high image quality over a longer period of time than that obtained by use of a combination with a photoreceptor having a surface layer of the siloxane resin, which is slightly inferior in terms of surface layer properties of water absorbability and gas barrier property.

The protective layer having the charge transportability and further having a crosslinked structure has excellent mechanical strength and satisfactory photoelectric properties, and can thus be directly used as a charge transporting layer in an image holding member having a laminate configuration. In this case, usual methods such as blade coating, Meyer bar coating, spray coating, dipping coating, bead coating, air knife coating, curtain coating or the like can be used. When necessary film thickness cannot be obtained by applying the coating solution once, the coating solution can be repeatedly applied to obtain a desired film thickness. When the coating solution is repeatedly applied, heating treatment may be carried out after each application or after repeated application.

A photosensitive layer having a single layer configuration is formed by incorporating the charge generation material and the binder resin. The binder resin can be similar to that used in the charge generating layer and the charge transporting layer. The content of the charge generation material in the photosensitive layer of single layer configuration is preferably in a range of about 10% by weight to about 85% by weight, preferably in a range of about 20% by weight to about 50% by weight.

For the purpose of improving photoelectric properties etc., the charge transport material and polymeric charge transport material may be added to the photosensitive layer having a single layer configuration. The amount thereof is preferably in a range of about 5% by weight to about 50% by weight. The compound represented by Formula (I) may also be added. As the solvent used in coating and the coating method, those described above can be used. The thickness of the coating is preferably in a range of about 5 μm to about 50 μm, and more preferably in a range of about 10 μm to about 40 μm.

### EXAMPLES

Hereinafter, while particularly preferable modes of the invention are listed, the invention is not necessarily limited to these modes.

“Parts” used in the following Examples unit “parts by weight”, and “%” used in the following Examples unit “% by weight”, unless otherwisely stated.

### <Measuring Methods for Various Properties>

Firstly, explanations are given for methods for measuring physical properties of the toners and the like used in the Examples and Comparative examples.

### (Molecular-Weight of Resin)

Measurement of molecular-weight distribution is conducted in the invention in the following manner. Experiments are conducted by using “HLC-8120GPC, SC-8020” (trade name, manufactured by Tosoh Corporation) as GPC, two columns of “TSKgel, Super HM-H (trade name, manufactured by Tosoh Corporation: 6.0 mm ID×15 cm)”, and THF (tetrahydrofuran) as an eluate. The experiment conditions are as follows: the sample concentration is 0.5%, the flow rate is 0.6 ml/min., the volume of a sample injected is 10 μl, the measurement temperature is 40° C., and an IR detector is used in the experiments. A calibration curve is prepared from 10 samples of “POLYSTYRENE STANDARD SAMPLE TSK STANDARD”, that is, A-500, F-1, F-10, F-80, F-380, A-2500, F-4, F-40, F-128 and F-700 (all trade names, manufactured by Tosoh Corporation).

### (Volume Average Particle Diameters of Resin Particle, Colorant Particle and the Like)

Volume average particle diameters of resin fine particles, colorant particles and the like are measured with a laser diffraction particle size measuring machine (trade name: SALD2000A, manufactured by Shimadzu Corporation).

### (Melting Point and Glass Transition Temperature of Resin)

The melting points of the toners and crystalline polyester resins and glass transition temperatures of the toners and non-crystalline resins are obtained from the respective maximum peak values measured in accordance with ASTMD3418-8. The glass transition temperature is set at a temperature at an intersection of extended lines of a base line and a rising-up line in an endothermic portion, and the melting point is set at a temperature at the summit of the endothermic peak.

A differential scanning calorimeter (trade name: DSC-60A, with an automatic cooler, manufactured by Shimadzu Corporation) is used to measure.

### <Preparation of Electrostatic Charge Image Developing Agent>

—Preparation of Non-crystalline Polyester Resin (A1) and Non-crystalline Resin Particle Dispersion (a1)—

In a heated and dried two-neck flask, 10 parts by mole of polyoxyethylene (2,0)-2,2-bis(4-hydroxyphenyl)propane, 90 parts by mole of polyoxypropylene (2,2)-2,2-bis(4-hydroxyphenyl)propane, 10 parts by mole of terephthalic acid, 67 parts by mole of fumaric acid, 3 parts by mole of n-dodecenyl succinic acid, 20 parts by mole of trimellitic acid and 0.05 parts by mole of dibutyltin oxide with respect to the acid components (a total moles of terephthalic acid, n-dodecenylsuccinic acid, trimellitic acid and fumaric acid) are charged, nitrogen gas is introduced inside of the flask to maintain an inert atmosphere, followed by elevating a temperature, at a temperature from 150° C. to 230° C., a copolycondensation is carried out for from 12 hr to 20 hr, further followed by gradually depressurizing at a temperature from 210° C. to 250° C. to synthesize a non-crystalline polyester resin (A1). A weight average molecular weight Mw of the resin is 70000 and the glass transition temperature Tg is 63° C.

In an emulsification tank of a high temperature and high pressure emulsifier (trade name: CABITRON CD1010, slit: 0.4 mm), 3000 parts of the obtained non-crystalline polyester resin, 10000 parts of ion exchange water and 90 parts of sodium dodecylbenzenesulfonate as a surfactant are charged, followed by heating to 130° C. to melt, further followed by dispersing at 110° C., at a flow rate of 3 L/m, and at 10000 revolutions for 30 min, still further followed by allowing to pass a cooling tank to recover a non-crystalline resin particle dispersion (high temperature and high pressure emulsifier (trade name: CABITRON CD1010, slit 0.4 mm)) to obtain a non-crystalline resin particle dispersion (a1).

—Preparation of Crystalline Polyester Resin (B1) and Crystalline Resin Particle Dispersion (b1)—

In a heated and dried three-neck flask, 44 parts by mole of 1,9-nonandiol, 56 parts by mole of dodecanedicarboxylic acid and, as a catalyst, 0.05 parts by mole of dibutyltin oxide are charged, followed by depressurizing and replacing air in the flask by a nitrogen gas to obtain an inert gas atmosphere, further followed by mechanically agitating at 180° C. for 2 hr. Thereafter, under reduced pressure, a temperature is gradually elevated to 230° C., followed by agitating for 5 hr, further followed by cooling when the mixture becomes viscous to stop the reaction, thereby a crystalline polyester resin (B1) is synthesized. A weight average molecular weight Mw of the resin is 30,000 and the melting point Tm is 74° C.

Thereafter, under the conditions the same as that of the preparation of the non-crystalline resin dispersion (A1), by use of a high temperature and high pressure emulsifier (trade name: CABITRON CD1010, slit: 0.4 mm), a crystalline resin particle dispersion (b1) is obtained.

### —Preparation of Colored Composition (1)—

To 100 parts of a press cake of a washed yellow pigment (trade name: C.I. PIGMENT YELLOW 75, manufactured by Hoechst Co.,), 2 parts of sodium dodecylbenzenesulfonate (solid content 60%) is added, followed by uniformly mixing, further followed by heating (60° C.), thereby a colored composition (1) is obtained. A moisture content of the resulting colored composition (1) is 60%.

### —Preparation of Colored Composition (2)—

Except that, in the preparation of the colored composition (1), the press cake of a yellow pigment is changed to a press cake of a yellow pigment (trade name: C.I. PIGMENT YELLOW 128, manufactured by Ciba Specialty Chemicals), similarly to the preparation of the colored composition (1), a colored composition (2) is obtained.

### —Preparation of Colored Composition (3)—

Except that, in the preparation of the colored composition (1), the press cake of a yellow pigment is changed to a press cake of a magenta pigment (trade name: C.I. PIGMENT RED 146, manufactured by Clarient Japan K. K.), similarly to the preparation of the colored composition (1), a colored composition (3) is obtained.

### —Preparation of Colored Composition (4)—

Except that, in the preparation of the colored composition (1), the press cake of a yellow pigment is changed to a press cake of a magenta pigment (trade name: C.I. PIGMENT RED 57:1, manufactured by Dainichiseika Color & Chemicals Mfg. Co., Ltd.), similarly to the preparation of the colored composition (1), a colored composition (4) is obtained.

### —Preparation of Colorant Dispersion (1)—

Yellow pigment (trade name: C.I. PIGMENT YELLOW 75, manufactured by Hoechst Co.,): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 0.12 μm and a concentration of the colorant particles is 23%.

### —Preparation of Colorant Dispersion (2)—

Yellow pigment (trade name: C.I. PIGMENT YELLOW 128, manufactured by Ciba Specialty Chemicals): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 0.14 μm and a concentration of the colorant particles is 23%.

### —Preparation of Colorant Dispersion (3)—

Magenta pigment (trade name: C.I. PIGMENT RED 146, manufactured by Clariant Japan K. K.): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 0.10 μm and a concentration of the colorant particles is 22%.

### —Preparation of Colorant Dispersion (4)—

Magenta Pigment (trade name: C.I. PIGMENT RED 57:1, manufactured by Dainichiseika Color & Chemicals Mfg. Co. Ltd.,): 35 parts
Anionic surfactant (trade name: PELEX NBL, Manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 0.16 μm and a concentration of the colorant particles is 24%.

### —Preparation of Colorant Dispersion (5)—

Coloring composition (1): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 135 μm and a concentration of the colorant particles is 23%.

### —Preparation of Colorant Dispersion (6)—

Colorant composition (2): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 130 μm and a concentration of the colorant particles is 22%.

### —Preparation of Colorant Dispersion (7)—

Colorant composition (3): 35 parts
Anionic surfactant (trade name: PELEX NBL, manufactured by Kao Corporation): 2 parts
Ion exchange water: 125 parts

The components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 120 μm and a concentration of the colorant particles is 20%.

### —Preparation of Colorant Dispersion (8)—

Colorant composition (4): 35 parts
Anionic surfactant (trade name: PELEX NBL, manufactured by Kao Corporation): 2 parts
Ion exchange water: 125 parts

Above components are mixed and dissolved and dispersed for 1 hr by use of a high-pressure impact type dispersing machine ULTIMIZER (trade name: HJP30006, manufactured by Sugino Machine Ltd.) to prepare a colorant dispersion in which a colorant is dispersed. A volume average particle diameter of a colorant in the colorant dispersion is 125 μm and a concentration of the colorant particles is 20%.

### —Preparation of Releasing Agent Particle Dispersion (1)—

Fatty acid amide wax (trade name: NEUTRON D, manufactured by Nippon Fine Chemical Co., Ltd.): 100 parts
Anionic surfactant (trade name: NEULEX R, manufactured by Nippon oil & Fats Co., Ltd.): 2 parts
Ion exchange water: 300 parts

The components are heated at 95° C. and dispersed by use of a homogenizer (trade name: ULTRA TURRAX T50, manufactured by IKA K. K.), followed by dispersing by use of a high-pressure Gaulin homogenizer (trade name, manufactured by Gaulin Co., Ltd.), thereby a releasing agent-dispersed releasing agent dispersion (1) (releasing agent concentration: 20% by weight) in which the releasing agent has a volume average particle diameter of 200 nm is prepared.

### (Preparation of Toner)

### <Preparation of Toner A1>

Non-crystalline resin particle dispersion (a1): 320 parts
Crystalline resin particle dispersion (b1): 80 parts
Colorant dispersion (1): 50 parts
Releasing agent particle dispersion: 60 parts
Aluminum sulfate (manufactured by Wako Pure Chemical Industries, Ltd.,): 5 parts
Aqueous solution of surfactant: 10 parts
Aqueous solution of 0.3M nitric acid: 50 parts
Ion exchange water: 500 parts
Aqueous solution of 10% TTHA (sodium triethylenetetramine hexaacetate, manufactured by Chelest Corporation): 0.5 parts

Among the components, an aqueous solution of 10% TTHA and the colorant dispersion (1) are mixed and agitated, followed by heating by use of a water bath set at 40° C. and maintaining there for 30 min, further followed by cooling, thereby a colorant dispersion mixture is obtained. Subsequently, the colorant dispersion mixture and the rest of the components are charged in a round stainless-steel flask and dispersed by use of a homogenizer (trade name: ULTRA TURRAX T50, manufactured by IKA K. K.), followed by heating up to 45° C. with agitation in a heating oil bath. After maintaining at 48° C. and when aggregated particles having an average particle diameter of substantially 5.2 μm are confirmed to be formed, additionally 100 parts of non-crystalline resin particle dispersion is added, followed by maintaining there further for 30 min.

Next, after 0.5 parts of an aqueous solution of 10% by weight of TTHA is further added, an aqueous solution of 1N sodium hydroxide is mildly added until the pH reaches 7.0, followed by heating to a predetermined temperature with the agitation continuing, further followed by keeping for a predetermined time. Thereafter, a reaction product is filtered and washed with ion exchange water, followed by drying by use of a vacuum dryer to obtain a toner mother particle.

### —Treatment by External Additive—

Thereafter, to 100 parts of the resulting toner mother particle, as external additives, 1.2 parts of calcium carbonate (trade name: SL1500, manufactured by Takehara Kagaku Kogyo K. K., new Mohs hardness: 3.0) and 1 parts of alumina (trade name: AKP30, manufactured by Sumitomo Chemical Co., Ltd., new Mohs hardness: 12.0) are mixed by use of Henschel Mixer to externally add, thereby a toner A1 is obtained.

### <Preparation of Toner A2>

Except that, in the preparation of the toner A1, the colorant dispersion (1) is changed to the colorant dispersion (2), similarly to the preparation of the toner A1, a toner A2 is obtained.

### <Preparation of Toner A3>

Except that, in the preparation of the toner A1, the colorant dispersion (1) is changed to the colorant dispersion (3), similarly to the preparation of the toner A1, a toner A3 is obtained.

### <Preparation of Toner A4>

Except that, in the preparation of the toner A1, the colorant dispersion (1) is changed to the colorant dispersion (4), similarly to the preparation of the toner A1, a toner A4 is obtained.

### <Preparation of Toner A5>

Except that, in the preparation of the toner A1, a usage amount of the colorant dispersion (1) is changed to 10 parts, similarly to the preparation of the toner A1, a toner A5 is obtained.

### <Preparation of Toner A6>

Except that, in the preparation of the toner A1, a usage amount of the colorant dispersion (1) is changed to 75 parts, similarly to the preparation of the toner A1, a toner A6 is obtained.

### <Preparation of Toner A7>

Except that, in the preparation of the toner A1, a usage amount of the colorant dispersion (1) is changed to 7 parts, similarly to the preparation of the toner A1, a toner A7 is obtained.

### <Preparation of Toner A8>

Except that, in the preparation of the toner A1, a usage amount of the colorant dispersion (1) is changed to 80 parts and the aqueous solution of 10% TTHA is not added, similarly to the preparation of the toner A1, a toner A8 is obtained.

### <Preparation of Toner A9>

Except that, in the preparation of the toner A1, a usage amount of the colorant dispersion (1) is changed to 65 parts, the aqueous solution of 10% TTHA is not added, a usage amount of the additional non-crystalline resin dispersion is changed to 30 parts and an adding external additive is changed to only 1.5 parts of titania (trade name: STR60-C-LP, manufactured by Sakai Chemical Industry Co., Ltd., new Mohs hardness: 11.0), similarly to the preparation of the toner A1, a toner A9 is obtained.

### <Preparation of Toner A10>

Except that, in the preparation of the toner A1, the colorant dispersion (1) is changed to the colorant dispersion (5), similarly to the preparation of the toner A1, a toner A10 is obtained.

### <Preparation of Toner A11>

Except that, in the preparation of the toner A1, the colorant dispersion (1) is changed to the colorant dispersion (6), similarly to the preparation of the toner A1, a toner A11 is obtained.

### <Preparation of Toner A12>

Except that, in the preparation of the toner A1, the colorant dispersion (1) is changed to the colorant dispersion (7), similarly to the preparation of the toner A1, a toner A12 is obtained.

### <Preparation of Toner A13>

Except that, in the preparation of the toner A1, the colorant dispersion (1) is changed to the colorant dispersion (8), similarly to the preparation of the toner A1, a toner A13 is obtained.

### <Preparation of Toner A14>

Except that, in the preparation of the toner A10, a usage amount of the colorant dispersion (5) is changed to 10 parts, similarly to the preparation of the toner A10, a toner A14 is obtained.

### <Preparation of Toner A15>

Except that, in the preparation of the toner A10, a usage amount of the colorant dispersion (5) is changed to 75 parts, similarly to the preparation of the toner A10, a toner A15 is obtained.

### <Preparation of Toner A16>

Except that, in the preparation of the toner A10, a usage amount of the colorant dispersion (5) is changed to 7 parts, similarly to the preparation of the toner A10, a toner A16 is obtained.

### <Preparation of Toner A17>

Except that, in the preparation of the toner A1, the adding external additive is changed to only 1.5 parts of titania (trade name: STR60C-LP, manufactured by Sakai Chemical Industry Co., Ltd.), similarly to the preparation of the toner A1, a toner A17 is obtained.

### <Preparation of Toner A18>

Except that, in the preparation of the toner A1, the adding external additive is changed to only 2.0 parts of alumina (trade name: AKP30, manufactured by Sumitomo Chemical Co., Ltd.), similarly to the preparation of the toner A1, a toner A18 is obtained.

### <Preparation of Toner A19>

Except that, in the preparation of the toner A10, the adding external additive is changed to only 1.8 parts of titania (trade name: STR60-C-LP, manufactured by Sakai Chemical Industry Co., Ltd.), similarly to the preparation of the toner A10, a toner A19 is obtained.

### <Preparation of Toner A20>

Except that, in the preparation of the toner A10, the adding external additive is changed to only 2.3 parts of alumina (trade name: AKP30, manufactured by Sumitomo Chemical Co., Ltd.), similarly to the preparation of the toner A10, a toner A20 is obtained.

### (Preparation of Developing Agent)

At first, 100 parts of ferrite particles (manufactured by Powder Tec K. K., average particle diameter: 50 μm) and 2.5 parts of a methyl methacrylate resin (manufactured by Mitsubishi Rayon Co., Ltd., weight average molecular weight: 95000) are charged together with 500 parts of toluene in a pressure type kneader and agitated and mixed at room temperature (25° C.) for 15 min, followed by heating up to 70° C. while mixing under reduced pressure to distill away toluene, further followed by cooling, still further followed by classifying by use of a sieve having an opening of 105 μm to prepare a ferrite carrier (resin-coated carrier).

Subsequently, the ferrite carrier and each of the toners A1 to A20 are mixed to prepare two component developing agents in which the toner concentration is 7% by weight.

### <Preparation of Photorecepter (Image Holding Member)>

### (Preparation of Photoreceptor 1)

A cylindrical A1 substrate is polished with a center-less polishing apparatus such that the ten points-average surface roughness Rz comes to be 0.6 μm. In a washing process, this cylinder is degreased, then etched for 1 minute in 2% by weight sodium hydroxide solution, neutralized and washed with pure water. In anodizing treatment, an anodized layer (current density: 1.0 A/dm2) is formed on the surface of the cylinder by 10% by weight sulfuric acid solution. After washing with water, the anodized layer is subjected to pore sealing by dipping in 1% by weight nickel acetate solution at 80° C. for 20 minutes. Then, the substrate is washed with pure water and dried. In this manner, an anodized layer having a thickness of 7 μm is formed on the surface of the aluminum cylinder.

1 part of titanyl phthalocyanine having a strong diffraction peak at a Bragg angle (2θ±0.2) of 27.2° in an X-ray diffraction spectrum is mixed with 1 part of polyvinyl butyral (trade name: S-LEC BM-S, manufactured by SEKISUI CHEMICAL CO., LTD.) and 100 parts of n-butyl acetate and dispersed together with glass beads in a paint shaker for 1 hour, and the resulting coating solution is applied by dip coating on the undercoat layer described above and dried by heating at 100° C. for 10 minutes to form a charge generating layer having about 0.15 μm in thickness.

Then, a coating solution prepared by dissolving 2 parts of a benzidine compound having the following structure (compound 1 below) and 2.5 parts of a polymer compound (compound 2 below, a viscosity average molecular weight: 39,000, n: a number of the repeating unit in the parenthesis) in 20 parts of chlorobenzene is applied by dipping coating on the charge generating layer and heated at 110° C. for 40 minutes to form a charge transporting layer of 20 μm in thickness, whereby a image holding member 1 is obtained.

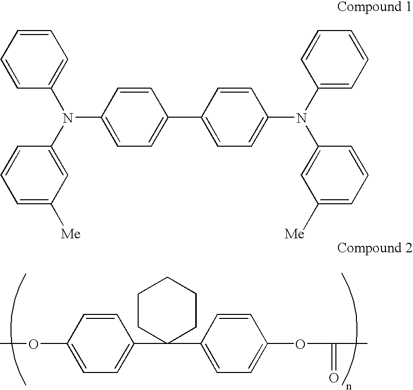

Furthermore, 5 parts of a compound 4 shown below, 7 parts of a resol phenol resin (trade name: PL-4852, manufactured by Gunei Chemical Industry Co., Ltd), 0.03 parts of methylphenylpolysiloxane and 20 parts of isopropanol are mixed and dissolved and thereby a coating solution for forming a protective layer is obtained. The coating solution is coated on a charge transporting layer of the image holding member by unit of a dip coating method and dried at 130° C. for 40 min, and thereby a image holding member on which a protective layer (the outermost surface layer) having a film thickness of 3 μm is formed is obtained. The oxygen permeability of the protective layer is 500 fm/s·Pa.

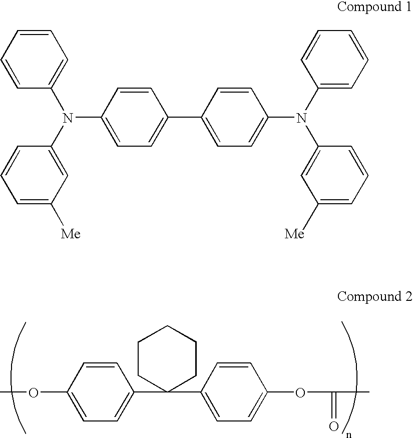

### (Preparation of Photoreceptor 2)

At first, 100 parts of zinc oxide (trade name: SMZ-017N, manufactured by Tayca Corp.) and 500 parts of toluene are mixed and agitated, to which 2 parts of a silane coupling agent (trade name: A1100, manufactured by Nippon Unicar Co., Ltd.) is added, followed by agitating for 5 hours. Thereafter, toluene is distilled off by distillation under reduced pressure, the mixture is baked at 120° C. for 2 hr, and thereby surface-treated zinc oxide is obtained.

Next, 35 parts of the surface-treated zinc oxide, 15 parts of a curing agent blocked isocyanate (trade name: SUMIDUR 3175, manufactured by Sumitomo Bayer Urethane Co., Ltd.), 6 parts of a butyral resin (trade name: S-LEC BM-1, manufactured by Sekisui Chemical Co., Ltd.) and 44 parts of methyl ethyl ketone are mixed and dispersed by use of a sand mill using glass beads having a particle diameter of 1 mm for 2 hours to obtain a dispersion. To the resulting dispersion, 0.005 part of dioctyltin dilaurate as a catalyst and 17 parts of silicone resin (trade name: TOSPEARL 130, manufactured by GE Toshiba Silicone Co., Ltd.) are added to obtain a coating solution for an undercoat layer.

The coating solution is coated on a 84 mm drawn tube substrate made of JISA3003 alloy by a dip coating method, followed by drying and curing at 160° C. for 100 minutes, thereby an undercoat layer having a thickness of 20 μm is obtained.

On the undercoat layer, a coating solution obtained in such a manner that 1 parts of chlorogallium phthalocyanine that has strong diffraction peaks at Bragg angles (2θ±0.2°) of 7.4°, 16.6°, 25.5° and 28.3° in an X-ray diffraction spectrum, 1 parts of polybutyral resin (trade name: BM-S, manufactured by Sekisui Chemical Co., Ltd.) and 100 parts of butyl acetate are mixed and dispersed with glass beads in a paint shaker for 1 hr is coated by a dip coating method and dried by heating at 100° C. for 10 minutes, thereby a charge generating layer having a film thickness of substantially 0.15 μm is formed.

Next, 3 parts of a polymer compound (the compound 2) and 2 parts of a benzidine compound (the compound 1) are dissolved in 20 parts of tetrahydrofuran to obtain a coating solution for a charge transporting layer. The coating solution for a charge transporting layer is coated on the charge generating layer by unit of a dip coating method to obtain a charge transporting layer and thereby, an electrophotographic photoreceptor 2 is obtained. The oxygen permeability of the protective layer is 1000 fm/s·Pa.

### (Preparation of Photoreceptor 3)

In the beginning, 2 parts of the compound 3 described in [0238] of JP-A No. 2006-0330278, 2 parts of the compound 4 and 0.05 parts of tetramethoxysilane are dissolved in 5 parts of isopropyl alcohol, 3 parts of tetrahydrofuran and 0.3 parts of distilled water, to which 0.05 parts of an ion exchange resin (trade name: AMBERLIST 15E) is added, followed by agitating at room temperature to hydrolyze for 24 hr.

From the resulting liquid, the ion exchange resin is filtered and separated. To 2 parts of the resulting filtrate, 0.04 parts of aluminum trisacetylacetonato and 0.02 parts of 3,5-di-tert-butyl-4-hydroxytoluene are added, and a resulting liquid is rendered a coating solution A for forming a surface protective layer. The coating solution A for forming a surface protective layer is coated by a dip coating method on a charge transporting layer of the image holding member before a protective layer in the image holding member 1 is formed and dried at room temperature for 30 min, followed by heating at 150° C. for 1 hr to cure. Thus, a surface protective layer having a film thickness of substantially 3 μm is formed, and, thereby a image holding member 3 is obtained. The oxygen permeability of the protective layer is 2500 fm/s·Pa.

### <Example 1 to 21, and Comparative Example 1 to 3>

### (Evaluation)

By use of a modified DocuCentre Color 400CP (having a process speed of 350 mm/s and provided with a image holding member shown in Table 2, charging unit, electrostatic latent image forming unit, toner image forming unit, transfer unit, fixing unit and cleaning unit, manufactured by Fuji Xerox Co., Ltd,), with a developing agent containing a toner shown in Table 2, under a high temperature and high humidity (28° C., 85% RH) environment, an image forming test (image coverage density is 5%) of 100000 sheets is carried out, followed by carrying out the image forming test of 100000 sheets under a low temperature and low humidity environment (10° C., 15% RH). A surface state of the photoreceptor and the cleaning blade after the image forming test of 200,000 in total are evaluated based on criteria below. Results are shown together with the B/A and ratio of nitrogen measured by X-ray photoelectron spectroscopy after the ion etching in Table 2. The surface state of the image holding member is observed by use of a loupe at a magnification of 50 and the change of the cleaning blade is observed by use of a laser microscope at a magnification of 100.

### (Surface State of Image Holding Member)

A: Adhesion and filming are not found even by a loupe observation.
B: A thin adhesion material is found in a periphery direction by a loupe observation but it is not observed in an image.
B⁻: A scratch and adhesion material are found but these do not affect largely on an image.
C: A small scratch is found on a surface and image density unevenness is found, that is, practically there is a little problem.
D: Due to image defects and scratches, practically there is a problem.

### (Change in Cleaning Blade)

A: There is found no wear in both an image portion and a non-image portion to be excellent.
B: There is difference between an image portion and non-image portions at a practically non-problematic level.
C: The wear is large in an image portion to be practically problematic depending on an image density.
D: The cleaning defect is caused to form a problematic streak on an image.

TABLE 2

| | Toner | | | | | |
|---|---|---|---|---|---|---|
| | contained in | | | | | |
| | used | | | | Surface state | Change |
| | Developing | | Ratio of nitrogen | | of | in |
| | Agent | B/A | after ion etching (atom %) | Used photoreceptor | photorecptor | cleaning blade |
| Example 1 | A1 | 0.25 | 3.5 | Photoreceptor 1 | A | A |
| Example 2 | A2 | 0.30 | 2.8 | Photoreceptor 1 | A | A |
| Example 3 | A3 | 0.32 | 4.2 | Photoreceptor 1 | A | A |
| Example 4 | A4 | 0.28 | 5.0 | Photoreceptor 1 | A | A |
| Example 5 | A5 | 0.02 | 0.12 | Photoreceptor 1 | B | B |
| Example 6 | A6 | 0.49 | 7.4 | Photoreceptor 1 | B | B |
| Example 7 | A10 | 0.27 | 3.8 | Photoreceptor 1 | A | A |
| Example 8 | A11 | 0.33 | 6.5 | Photoreceptor 1 | B | A |
| Example 9 | A12 | 0.27 | 4.0 | Photoreceptor 1 | B | B |
| Example 10 | A13 | 0.35 | 3.5 | Photoreceptor 1 | B | B |
| Example 11 | A14 | 0.40 | 2.2 | Photoreceptor 1 | B | B |
| Example 12 | A15 | 0.27 | 6.0 | Photoreceptor 1 | B | B |
| Example 13 | A16 | 0.32 | 3.4 | Photoreceptor 1 | A | B |
| Example 14 | A17 | 0.47 | 3.7 | Photoreceptor 1 | B | B |
| Example 15 | A18 | 0.24 | 2.5 | Photoreceptor 1 | B⁻ | B |
| Example 16 | A19 | 0.15 | 1.8 | Photoreceptor 1 | B⁻ | B |
| Example 17 | A20 | 0.17 | 2.5 | Photoreceptor 1 | B | B |
| Example 18 | A1 | 0.25 | 3.5 | Photoreceptor 2 | B | B |
| Example 19 | A1 | 0.30 | 2.8 | Photoreceptor 3 | B | B |
| Example 20 | A10 | 0.27 | 3.8 | Photoreceptor 2 | B | B |
| Example 21 | A10 | 0.27 | 3.8 | Photoreceptor 3 | B | B |
| Comparative | A7 | 0.009 | 0.085 | Photoreceptor 1 | C | C |
| Example 1 | | | | | | |
| Comparative | A8 | 0.52 | 7.6 | Photoreceptor 1 | D | C |
| Example 2 | | | | | | |
| Comparative | A9 | 0.48 | 7.7 | Photoreceptor 1 | C | D |
| Example 3 | | | | | | |

From Table 2, it is found that Example 1 to 21 are excellent in both the surface state of the photoreceptor and change in cleaning blade after the image forming test of 200,000 sheets in total.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic toner comprising:
a binder resin; and
a colorant,
with a total intensity (keps) of all elements detected in the toner due to fluorescent X-ray measurement designated as A and an intensity of nitrogen designated to B, B/A being from about 0.01 to about 0.5; and
a ratio of nitrogen measured by X-ray photoelectron spectrometry after ion etching at an accelerating voltage of 10 mV for 180 seconds being from about 0.1 atom % to about 7.5 atom %.

2. The electrophotographic toner of claim 1, wherein a weight average molecular weight of the binder resin is about 10,000 or more.

3. The electrophotographic toner of claim 1, wherein the colorant includes a pigment and an aliphatic sulfonate and/or aromatic sulfonate having 6 to 20 carbon atoms.

4. The electrophotographic toner of claim 3, wherein the colorant is obtained by mixing an aliphatic sulfonate and/or aromatic sulfonate having 6 to 20 carbon atoms with a synthesized and washed wet cake pigment, followed by heating.

5. The electrophotographic toner of claim 1, wherein the colorant contains a colorant having a structure in which at least an azo group bonds to a benzene ring or a naphthalene ring.

6. The electrophotographic toner of claim 1, wherein the colorant contains a copper phthalocyanine pigment.

7. The electrophotographic toner of claim 1, wherein the colorant contains a quinacridone pigment.

8. The electrophotographic toner of claim 1, wherein the colorant contains a monoazo pigment.

9. The electrophotographic toner of claim 1, wherein a volume average particle size distribution index GSDv of the toner is about 1.28 or less.

10. The electrophotographic toner of claim 1, wherein an average circularity of the toner is from about 0.940 to about 0.980.

11. The electrophotographic toner of claim 1, further comprising at least two external additives (low hardness external additive and high hardness external additive) having different Mohs hardness.

12. The electrophotographic toner of claim 11, wherein the Mohs hardness of the low hardness external additive is from about 2 to about 6.

13. The electrophotographic toner of claim 11, wherein a content ratio of the low hardness external additive and the high hardness external additive (low hardness external additive:high hardness external additive, % by weight) is from about 20:80 to about 80:20.

14. The electrophotographic toner of claim 1, wherein the electrophotographic toner is produced by a process comprising:
dispersing a colorant;
preparing a colorant dispersion for preparing a colorant dispersion by charging a chelate dispersion to the dispersed colorant, followed by mixing and agitating;
forming aggregated particles by mixing a resin fine particle dispersion in which resin fine particles are dispersed and the colorant dispersion; and
fusing and coalescing by heating the aggregated particles at a temperature equal to or greater than the glass transition temperature of the resin fine particles.

15. An electrophotographic developing agent comprising the electrophotographic toner of claim 1.

16. A toner cartridge that is detachable from an image forming apparatus provided with at least a toner image forming unit and stores a developing agent containing a toner for being supplied to the toner image forming unit, the toner being the electrophotographic toner of claim 1.

17. A process cartridge that is detachable from an image forming apparatus, the process cartridge comprising at least:
an image holding member; and
toner image forming unit that stores a developing agent and supplies the developing agent to an electrostatic latent image formed on the image holding member surface to form a toner image,
the developing agent being the electrophotographic developing agent of claim 15.

18. An image forming apparatus comprising at least:
an image holding member;
a charging unit for charging a surface of the image holding member;
an electrostatic latent image forming unit for forming an electrostatic latent image on a surface of the charged image holding member;
a toner image forming unit for forming a toner image by developing the electrostatic latent image with a developing agent;
a transferring unit for transferring the toner image onto a recording medium surface;
a fixing unit for fixing the toner image transferred onto the surface of the recording medium; and
a cleaning unit for removing toner remaining on the surface of the image holding member after transferring,
the developing agent being the electrophotographic developing agent of claim 15.

19. The image forming apparatus of claim 18, wherein the image holding member is an electrophotographic image holding member having an outermost surface layer, and an oxygen permeability of the outermost surface layer is about 2,500 fm/s·Pa or less.
